(19) United States
(12) Patent Application Publication
(10) Pub. No.: US 2017/0315804 A1
(43) Pub. Date: Nov. 2, 2017

(54) SYSTEM, APPARATUS, AND METHOD FOR SUBTERRANEAN TERMITE CONTROL

(71) Applicants: Tony Nick Frudakis, Bradenton, FL (US); Oliver Petereit, Bradenton, FL (US)

(72) Inventors: Tony Nick Frudakis, Bradenton, FL (US); Oliver Petereit, Bradenton, FL (US)

(21) Appl. No.: 15/653,298

(22) Filed: Jul. 18, 2017

Related U.S. Application Data
(63) Continuation-in-part of application No. 15/243,097, filed on Aug. 22, 2016, now abandoned.
(60) Provisional application No. 62/208,310, filed on Aug. 21, 2015.
(60) Provisional application No. 62/277,855, filed on Jan. 12, 2016.

(51) Int. Cl. G06F 9/00; A01N 61/00; G08B 13/18; G08B 13/22

(52) U.S. Cl. CPC G06F 9/00; G08B 13/22; A01N 61/00; G08B 13/18

(57) ABSTRACT

A system, apparatus, and method for use in controlling subterranean insect population and for use in irrigation is provided. Characteristics are monitored in a plurality of under and above soil level regions. The characteristics may include, for example, thermal heat or moisture level characteristics; seismic-type, vibrational, or acoustic characteristics indicative of air pockets or tunnels created by a subterranean insect population; or sound or acoustic levels produced by a subterranean insect population. It is determined whether one or more of the characteristics in one or more of the soil regions are indicative of a subterranean insect population exceeding a threshold or have a need for irrigation. Based on the determining, a treatment need is identified for the one or more soil regions. The treatment need is executed at regions corresponding to the one or more soil regions.

### CROSS-REFERENCE TO RELATED APPLICATIONS

The present continuation-in-part patent application claims priority benefit of U.S. nonprovisional patent application Ser. No. 15/243,097 entitled “SYSTEM, APPARATUS, AND METHOD FOR SUBTERRANEAN TERMITE CONTROL” filed 22 Aug. 2016, which further claims priority to U.S. provisional application for patent serial number 62208310 entitled “SYSTEM, APPARATUS, AND METHOD FOR SUBTERRANEAN TERMITE CONTROL” FILED 21 Aug. 2015 and Ser. No. 62/277,855 FILED 12 Jan. 2016 under 35 U.S.C. 119(e). The contents of these related applications are incorporated herein by reference for all purposes to the extent that such subject matter is not inconsistent herewith or limiting hereof.

### RELATED CO-PENDING U.S. PATENT APPLICATIONS

CIP of Ser. No. 15/243,097 filed Aug. 22, 2016

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a system, apparatus and method for pest and irrigation control. More particularly, certain embodiments of the invention relate to system, apparatus and method for control of subterranean termite.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Termites are typically known to cause damage to wood, including, structures made of wood like homes, furniture's, etc. . . . . It is believed that the damage combined by flood, fire, hail and storm is less than half of termite damage per year. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that there are few methods used for termite control in the art like, using bait traps with or without poison; contact-based controls, for example, thermocouple; non-contact based controls, for example, infrared imaging; and the like.

In view of the foregoing, it is clear that these traditional techniques are not perfect and leave room for more optimal approaches.

### SUMMARY OF THE INVENTION

In one aspect, a system includes a first computing device, wherein the first computing device is operably coupled with an insect control device; the insect control device, wherein the insect control device comprises a second computing device and a sensor, wherein the sensor is enabled to monitor characteristics in a vicinity of the insect control device, wherein the insect control device is partially embedded in soil in the vicinity where the characteristics are monitored, wherein the insect control device is enabled to transmit the characteristics from the vicinity of the insect control device to the first computing device; and an insect treatment unit, configured to provide an insect treatment on receiving a communication from the first computing device based on the on the characteristics transmitted by the insect control device.

In another aspect, a method includes providing a system for insect control, wherein the system comprises a first computing device, and an insect control device, wherein the first computing device is operably coupled with the insect control device; monitoring characteristics in a plurality of soil regions using the insect control devices, wherein the insect control device comprises a second computing device and a sensor, wherein the sensor is enabled to monitor characteristics in a vicinity of the insect control device, wherein the insect control device is partially embedded in soil in the vicinity where the characteristics are monitored, wherein the insect control device is enabled to transmit the characteristics from the vicinity of the insect control device to the first computing device; determining whether one or more of the characteristics in one or more of the soil regions are indicative of an insect population exceeding a threshold value, wherein the determining is done by the first computing device using a designated computer program; identifying a treatment need at the soil regions based on the determining, wherein the identifying is done by the first computing device using a designated computer program; and executing the treatment need at the soil regions based on the identifying, wherein the executing is done by the first computing device using a designated computer program; and controlling or eliminating the insect population.

In a further aspect, a method includes providing a system for chemi-irrigation control, wherein the system comprises a first computing device, and an insect control device, wherein the first computing device is operably coupled with the insect control device; monitoring characteristics in a plurality of soil regions using the insect control devices, wherein the insect control device comprises a second computing device and a sensor, wherein the sensor is enabled to monitor characteristics in a vicinity of the insect control device, wherein the insect control device is partially embedded in soil in the vicinity where the characteristics are monitored, wherein the insect control device is enabled to transmit the characteristics from the vicinity of the insect control device to the first computing device; determining whether one or more of the characteristics in one or more of the soil regions are indicative of a need for chemi-irrigation, wherein the determining is done by the first computing device using a designated computer program; identifying a treatment need at the soil regions based on the determining, wherein the identifying is done by the first computing device using a designated computer program, wherein the treatment need is selected from water irrigation and pesticide or insecticide release; and executing the treatment need at the soil regions based on the identifying, wherein the executing is done by the first computing device using a designated computer program; controlling or eliminating the insect/pest population and for keeping the soil irrigated.

In yet another aspect, a device includes a first computing and a second computing device, wherein the second computing devices is operably coupled with a first computing device, the device being partially embedded in soil, the device having a portion above soil level and a portion below level; at least one sensor, wherein the at least one sensor is placed in the portion of the device below soil level, wherein the sensor is configured to monitor a characteristic in the vicinity of the device; wherein the second computing device, configured to transmit the characteristic to the first computing device.

In another aspect, a device includes a body being partially embedded in soil, the body having a portion above soil level and a portion below level; at least one sensor placed in the portion of the body below soil level, wherein the sensor is configured to monitor a below soil level characteristic in the vicinity of the device, wherein the below soil level characteristics comprises: sound or acoustic waves produced by an insect population, propagation characteristics of an electromagnetic wave, dielectric characteristics, Time Domain Reflectometry (TDR) characteristics, thermal characteristics, moisture/humidity characteristics, pH level, a vibration level, an acoustic level, and a mineral level of at least one mineral in the soil; and a treatment unit to dispense an insect treatment.

Advantages of the system may include one or more of the following. The system supports both automated irrigation and automated chemi-irrigation system for pesticide application (above and/or below ground) that is driven by insect detecting sensors. In contrast, conventional insect sensors for above ground pests using methods like optical or laser occlusion within small bait box areas that contain an attractant. The system provides insect sensor for underground termites based on Time Domain Spectroscopy (TDS—all the other methods in our patent presently are speculation at this point). The TDS method is well described in the patent. The system provides an underground pesticide dispersal system using drip irrigation tubing for slow leeching of solution into the soil underground without clogging problems inherent to other methods one can envision. The system is highly efficient and cost effective for controlling termites and underground insects, mosquitos, roaches, ants and other above ground insects.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system for insect control, in accordance with an embodiment of the present invention;

FIG. 2 illustrates an architecture of an exemplary system for insect control, in accordance with an embodiment of the present invention;

FIG. 3A is a perspective view illustrating an exemplary insect control device, in accordance with an embodiment of the present invention;

FIG. 3B is a three-dimensional view illustrating an exemplary insect control device, in accordance with an embodiment of the present invention;

FIGS. 3C-3D show two exemplary TDR sensor embodiments, while FIG. 3E shows an exemplary TDR system and FIG. 3F shows an exemplary protected area.

FIG. 4 is a perspective view illustrating an exemplary insect control device, in accordance with an embodiment of the present invention;

FIG. 5 is a perspective view illustrating an exemplary insect control device, in accordance with an embodiment of the present invention;

FIG. 6 is a perspective view illustrating a typical layout of insect control devices for a typical residence, in accordance with an embodiment of the present invention;

FIG. 7 is a perspective view illustrating a typical layout of insect control devices for a typical residence, in accordance with an embodiment of the present invention;

FIG. 8 is a perspective view illustrating an overview of the system for termite control in accordance with an embodiment of the present invention;

FIG. 9 is a flow chart illustrating a method for insect control in accordance with an embodiment of the present invention;

FIG. 10 is a block diagram depicting an exemplary client/server system which may be used by an exemplary web-enabled/networked embodiment of the present invention; and

FIG. 11 illustrates a block diagram depicting a conventional client/server communication system.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

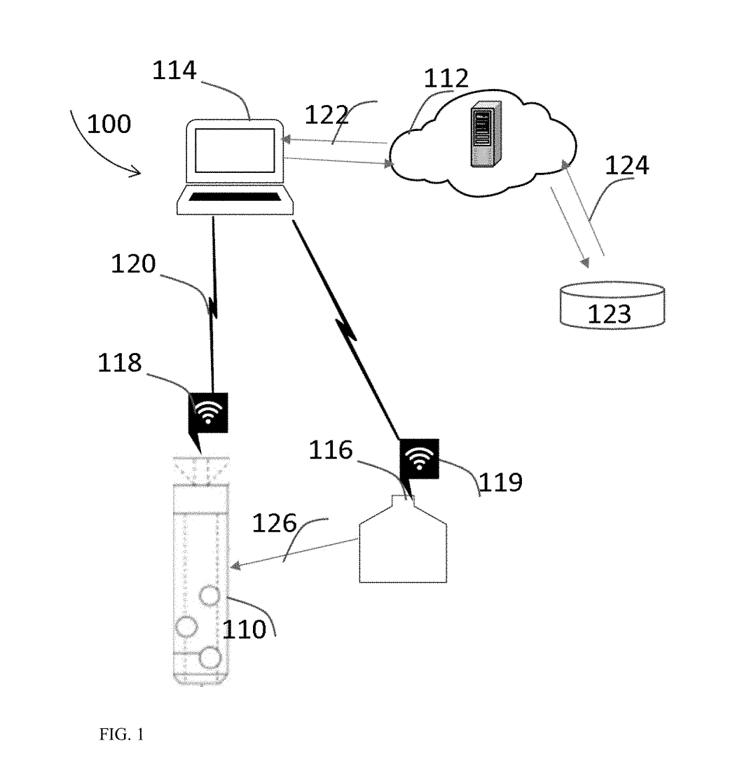

In various embodiments, a system, method, and device are provided for insect control. Referring to FIG. 1 is illustrated an exemplary system for insect control 100, in accordance with an embodiment of the present invention. The system for insect control 100 may include an insect control device 110, a server 112, a first computing device 114, and an insecticide reservoir 116. Server 112 may be any computing platform that executes computer software and/or code from a non-transitory computer readable medium. Server 112 may also access a database 123 containing information on characteristics, user history, chemical information for insecticides, MSDS (material safety data sheet) information on insecticides, weather information, local ordinances, among other required information for the system for insect control. In some embodiments, system 100 may comprise two or more insect control devices 110, and two or more servers 112 with databases 123.

During a typical working of the insect control system, the insect control device may be inserted at various locations in a given area or region. The insect control device may include one or more sensors, where the sensors may be capable of sensing and monitoring certain characteristics in its vicinity. In one embodiment, the insect control device 110 may be inserted at least partially underground, for example, spaced out around the perimeter of a residence in a manner that the sensor fields overlap. The insect control device 110 may include a second computing device (not shown in figure) which may be capable of wirelessly communicating 118 information on the characteristics in the vicinity of the insect control device 110 to the first computing device 114. In certain embodiments, the first computing device 114 may then communicate 122 information on the soil characteristics to the server 112. The first computing device 114 may include a designated computer program to determine, identify, and execute a required quantity of an insecticide to be dispensed for insect control in an identified region. In one embodiment, the first computing device 114 may connect 122, 124 to the server 112 and the database 113, and integrate the information on the characteristics from the insect control device 110 to determine a treatment regimen for the insects being targeted. The insecticide reservoir 116 may include a level sensor (not shown in figure) and a third computing device (not shown in figure). The insecticide reservoir 116 may be capable of wirelessly receiving 119 instructions from the first computing device 114 to dispense 126 the required quantity of the insecticide to the insect control device 110 and the insect control device 110 may in turn dispense the required quantity of the insecticide in the soil. The insecticide reservoir 116 may be capable of wirelessly sending 119 insecticide level information to the first computing device 114. Accordingly, in one embodiment, the steps of determining, identifying, and executing may be performed at the first computing device 114.

In one embodiment, the first computing device with or without communication with the server and database, may be configured to determine whether the data provided by the sensors are indicative of a subterranean insect population exceeding a threshold value, identify a treatment need based on the determining, and execute the treatment need in response to the identifying. The first computing device may be coupled to a first wireless transceiver, each insect control device may be coupled to a second wireless transceiver, and the second wireless transceiver may communicate wireless signals carrying the sensor data to the first computing device.

It may be appreciated by a person with ordinary skill in the art, in light of and in accordance with the teachings of the present invention, the computing devices may include virtually any computer device capable of determining, identifying, and executing necessary details and instructions for insecticide dispensation to the insect control device. Non-limiting examples of the computing devices may include a computer, a smart phone, microprocessor and the like. The computing devices may include any computing platform that executes computer software and/or code from a non-transitory computer readable medium. The computing devices may include a single device or multiple devices. In embodiments where the first computing device 114 is a single device all the functions of determining, identifying, and executing the details and instructions of insecticide dispensation, may be executed by the single first computing device 114. In embodiments where the first computing device 114 includes multiple devices these functions may be distributed between the multiple devices. For example, the determining and identifying may be done by one computing device and the executing may be done by a second device. In another embodiment, the first computing device 114 is a single device.

It may be appreciated by a person with ordinary skill in the art, in light of and in accordance with the teachings of the present invention, that the first computing device 114 may connect to any number of devices with virtually any wired and/or wireless means. The computing device may connect to virtually any device by means such as, but not limited to, Bluetooth connection, Ethernet cable, USB cable, WIFI, IRDA, etc. . . . . In one embodiment, the computing device 114 may connect to other devices for determining, identifying, and executing necessary details and instructions for insecticide dispensation to the insect control device. In another embodiment, the computing device may connect to other devices for transmitting the determined, identified, and execution of necessary details and instructions for insecticide dispensation to the insect control device.

It may be appreciated by a person with ordinary skill in the art, in light of and in accordance with the teachings of the present invention, that the database may include, but not be limited to, a plurality of data servers, and a memory card. It may be appreciated by a person with ordinary skill in the art, in light of and in accordance with the teachings of the present invention, that the storage device may include a database that stores the information on determining, identifying, and executing necessary details and instructions for insecticide dispensation to the insect control device. In another embodiment, the information on determining, identifying, and executing necessary details and instructions for insecticide dispensation to the insect control device may be stored in a memory card in the first computing device 114.

It may be appreciated by a person with ordinary skill in the art, in light of and in accordance with the teachings of the present invention that, the information on determining, identifying, and executing necessary details and instructions for insecticide dispensation to the insect control device may partially or completely be contained in a local computing platform and/or network. In an alternative embodiment of the present invention, the information on determining, identifying, and executing necessary details and instructions for insecticide dispensation to the insect control device may be located on a local computer network.

It may be appreciated by a person with ordinary skill in the art, in light of and in accordance with the teachings of the present invention, the storage device may include any portable storage device or the storage device may be internet based. Non-limiting examples of portable storage media include computer readable devices like USB, DVD, etc. . . . Non-limiting examples of internet based storage media include cloud drive, data download web link, etc. . . . .

In one embodiment, the insect control device may be termite control device and the insect may be termites. The insect control device may also be referred to as a rod, probe, stick, etc. . . . .

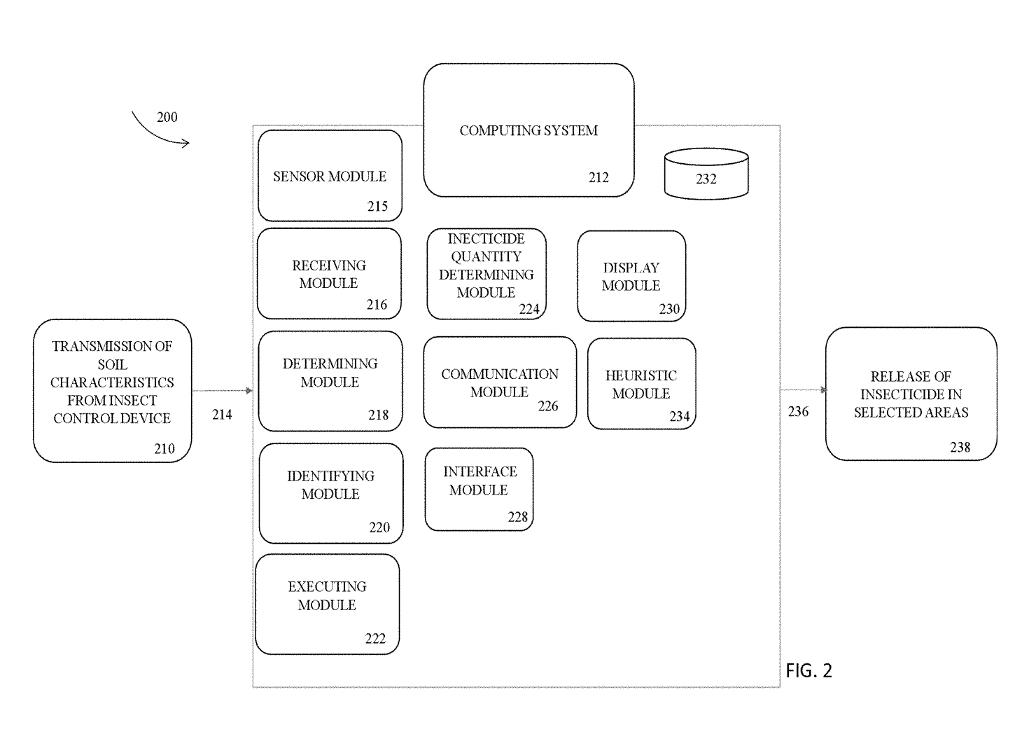

Referring to FIG. 2, is illustrated an architecture of an exemplary system for sharing status of applications, in accordance with an embodiment of the present invention. The architecture 200 may comprise a computing system 212. The computing system 212 includes a sensor module 215, a receiving module 216, a determining module 218, an identifying module 220, an executing module 222, an insecticide quantity determining module 224, a communication module 226, an interface module 228, a display module 230, a database 232, and a heuristic module 234. Preferably, the system applies time domain spectroscopy (TDS), as described in detail below. The system also works with light sensors (cameras) and lasers in other embodiments. The system can be used to provide insect sensor driven chemi-irrigation for rmostiquoes, roaches, among others. The system can dispense pesticides in liquid or solid form. The pesticide can be in a dispensing tank if in liquid form, or can be in the form of pellets in in solid form, for example. The pesticide can be organic, inorganic, among others. The pesticide can be petroleum based or non-petroleum based (such as a natural pesticide, for example. The pesticide can be a nano or micro-encapsulated solid in one embodiment. The pesticide can be a single chemical composition, or can be a mixture or collection of chemicals. In one embodiment, the pesticide can be a slow release composition such as those disclosed in co-pending application entitled “PESTICIDE COMPOSITION FOR INSECT SENSOR DRIVEN CHEMI-IRRIGATION” with Ser. No. ______, filed concurrently herewith, the content of which is incorporated by reference.

The sensor module 215, may have a means of reading the sensor data transmitted from the sensors on or in the vicinity of the insect control device 210 to 214 the computing device 212, such as, without limitation, a processing unit, a computer, or a server to execute computer code and/or algorithms from a non-transitory computer readable medium, from monitoring the soil and other characteristics for 236 release of an insecticide in selected areas 238. The receiving module 216, may have a means of receiving 214 the sensor data transmitted from the sensors on or in the vicinity of the insect control device 210, such as, without limitation, a processing unit, a computer, or a server to execute computer code and/or algorithms from a non-transitory computer readable medium. The determining module 218, may have a means of determining an action to be taken based on the sensor data transmitted from the sensors on or in the vicinity of the insect control device 210, such as, without limitation, a processing unit, a computer, or a server to execute computer code and/or algorithms from a non-transitory computer readable medium, for 236 release of an insecticide in selected areas 238. The identifying module 220, may have a means of identifying an action to be taken based on the sensor data transmitted from the sensors on or in the vicinity of the insect control device 210, such as, without limitation, a processing unit, a computer, or a server to execute computer code and/or algorithms from a non-transitory computer readable medium, for 236 release of an insecticide in selected areas 238. The executing module 222, may have a means of determining an action to be taken based on the sensor data transmitted from the sensors on or in the vicinity of the insect control device 210, such as, without limitation, a processing unit, a computer, or a server to execute computer code and/or algorithms from a non-transitory computer readable medium, for 236 release of an insecticide in selected areas 238. The insecticide determining module 224, may have a means of determining amount of insecticide to be dispensed based on the sensor data transmitted from the sensors on or in the vicinity of the insect control device 210, such as, without limitation, a processing unit, a computer, or a server to execute computer code and/or algorithms from a non-transitory computer readable medium, for 236 release of an insecticide in selected areas 238. The communication module 226, may have a means of communicating an action to be taken based on the sensor data transmitted from the sensors on or in the vicinity of the insect control device 210, such as, without limitation, a processing unit, a computer, or a server to execute computer code and/or algorithms from a non-transitory computer readable medium, for 236 release of an insecticide in selected areas 238. The interface module 218, may have a means of providing an interface, for example, between the server and the computing device, the server or the computing device and the insect control device, the server or the computing device and the reservoir, etc., such as, without limitation, a processing unit, a computer, or a server to execute computer code and/or algorithms from a non-transitory computer readable medium, for 236 release of an insecticide in selected areas 238. The display module 230 may have a means to display an action to be taken based on the sensor data transmitted from the sensors on or in the vicinity of the insect control device 210, such as, without limitation, a display screen on a computing system 212, to a user to make any necessary edits or modifications for 236 release of an insecticide in selected areas 238. The data storage module 232 may include a database as described herein above, wherein the database may include, means for storing sensor data transmitted from the sensors on or in the vicinity of the insect control device 210 for 236 release of an insecticide in selected areas 238. The databases may include, but not be limited to, a plurality of data servers, and a memory card. The heuristic module 234, may have a means of self-learning, such as, without limitation, a processing unit, a computer, or a server to execute computer code and/or algorithms from a non-transitory computer readable medium to assist the assimilation of sensor data transmitted from the sensors on or in the vicinity of the insect control device 210 for 236 release of an insecticide in selected areas 238.

It may be appreciated by a person with ordinary skill in the art, in light of and in accordance with the teachings of the present invention, that one or more modules may be embodied in a single device. In an alternative embodiment of the present invention, all modules except the application operating module and capture module may be embodied in a personal computer or laptop device. The personal computer or laptop device, notebook computer, table, pad, or smart phone may be capable of monitoring, determining, identifying and executing based on sensor data captured and transmitted to the personal computer or laptop device from the sensors on or in the vicinity of the insect control device 210 for 236 release of an insecticide in selected areas 238.

It may be appreciated by a person with ordinary skill in the art, in light of and in accordance with the teachings of the present invention, that a designated computer program may be used to monitor, determine, identify and execute based on sensor data captured and transmitted to the personal computer or laptop device or server from the sensors on or in the vicinity of the insect control device 210 for 236 release of an insecticide in selected areas 238.

It may be appreciated by a person with ordinary skill in the art, in light of and in accordance with the teachings of the present invention, that virtually any algorithm and/or computer code may be used to monitor, determine, identify and execute based on sensor data captured and transmitted to the personal computer or laptop device or server from the sensors on or in the vicinity of the insect control device 210 for 236 release of an insecticide in selected areas 238.

A plurality of modules such as, without limitation, a sensor module 215, a receiving module 216, a determining module 218, an identifying module 220, an executing module 222, an insecticide quantity determining module 224, a communication module 226, an interface module 228, a display module 230, a database 232, and a heuristic module 234 may be present in the architecture 200 for insect control system. The plurality of similar modules may work in parallel or independently to improve the throughput and/or speed of architecture 200 for 236 release of an insecticide in selected areas 238. In an alternative embodiment of the present invention, a plurality of sensor, receiving, determining, identifying, executing, display, communicating, and storage modules may be connected for 236 release of an insecticide in selected areas 238 via wired and wireless connections to access resources from different wired and wireless networks. In still another alternative embodiment of the present invention, a plurality of similar modules may form a secondary application status sharing system capable of seamlessly substituting an errant module.

It may be appreciated by a person with ordinary skill in the art, in light of and in accordance with the teachings of the present invention, that one or more modules may transmit capture information to a tech support server that is on an accessible network or over the internet. In an alternative embodiment of the present invention, additional captured information may be sent to a server to alleviate processing load on an application status sharing system, for example, if multiple variations of the applications status are being simultaneously shared.

It may be appreciated by a person with ordinary skill in the art, in light of and in accordance with the teachings of the present invention, that any module in architecture 200 may perform data manipulation. Data manipulation such as, but not limited to, compression, encryption, formatting, etc . . . . . In an alternative embodiment of the present invention, any module sending data may first compress the data prior to data transmission.

In one embodiment, the soil characteristics may include, but may not be limited to, thermal i.e., heat or moisture characteristics; seismic-type, vibrational, or acoustic characteristics indicative of air pockets or tunnels created by a subterranean insect population; and sound or acoustic levels produced by a subterranean insect population. In one embodiment, characteristics other than soil characteristic may be monitored. The other characteristics may be indicative of favorable or unfavorable treatment conditions. These other characteristics may involve a weather characteristic, which may include one of a temperature, a humidity, a wind speed, and an insolation characteristic. The execution of the treatment need may be delayed based on the determining of an unfavorable treatment condition. In certain embodiments, the other sensed characteristics may include, for example, pH, detection of minerals such as phosphorus, potassium, calcium, magnesium, sodium, sulfur, manganese, copper, zinc, and the like.

In one embodiment, the server may include, a central controller, a cloud server, and the like. In one embodiment, the monitoring of the characteristics may include monitoring the soil characteristics at a plurality of locations where the insect control device may be inserted in the soil.

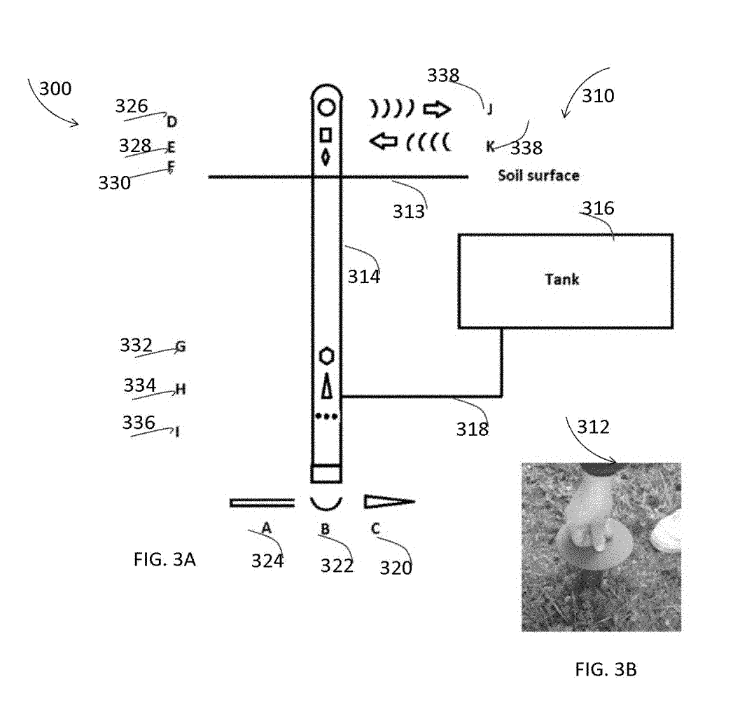

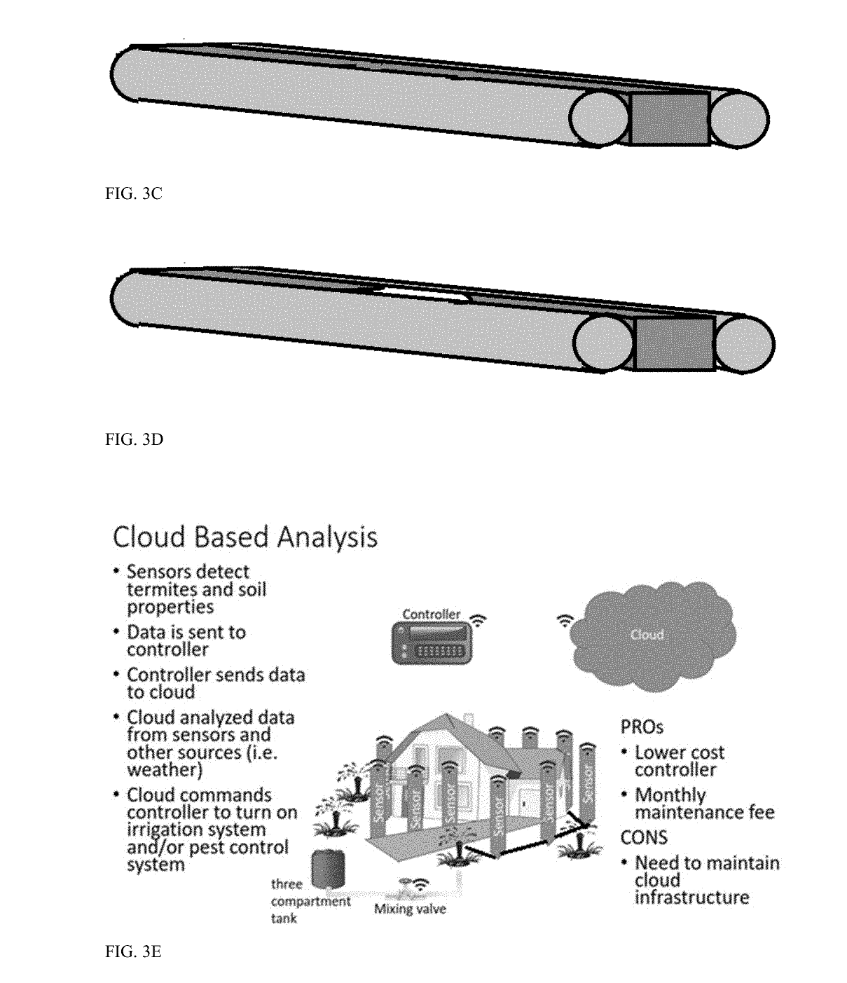

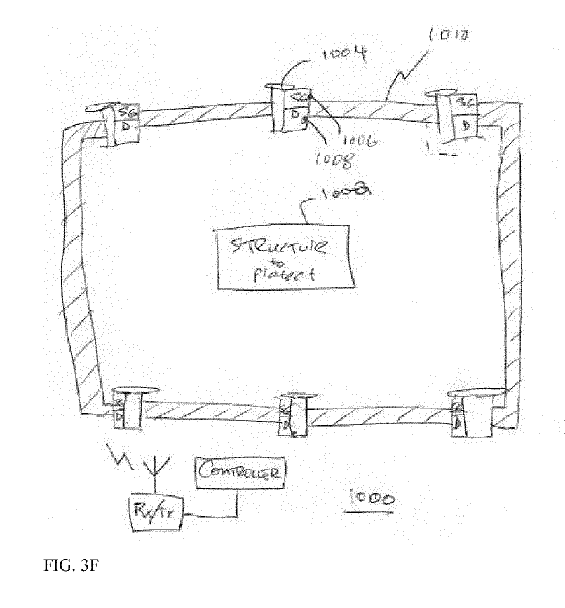

In one embodiment, the insect control device may include at least one sensor for sensing an underground characteristic in a region where the insect control device may be at least partially inserted. In one embodiment, the reservoir may be configured to hold an insecticide and connect to a plurality of dispensers. Each insect control device can dispense on its own, or in tandem with other control devices in a networked fashion, at either each device locally or through interconnected perforated tubing for local dispensing at the local controller. One controller can be dedicated to one insect control device, or one controller can control a plurality of insect control devices. In one embodiment, the dispensers may be operably coupled to the insect control device as described with reference go FIG. 3A. The central controller may be configured to receive data from the sensors, and to control release of the termiticide via one or more of the dispensers based on assessing the data. Instead of using the reservoir and termiticide, other alternative techniques may be employed as the treatment need for termite control.

Referring to FIGS. 3A and 3B, is illustrated 300 a perspective view 310 and a three-dimensional view 312 of an insect control device in accordance with an embodiment of the present invention. It may be appreciated by a person with ordinary skill in the art, in light of and in accordance with the teachings of the present invention, that the insect control device 314 may be manufactured having a length convenient for use in a given region or area. In one exemplary embodiment, the insect control device may have a length in range of about 0.1, 0.2, 0.3, 0.4, or 05 foot, or can be one foot, two feet, six feet to about ten feet. As mentioned herein above, in one embodiment, the insect control device may be at least partially embedded under the soil surface 313. In one embodiment, as mentioned hereinabove, the insecticide may be stored in a tank or reservoir 316. The tank 316 may be operably connected to the insect control device 314 through 318 a hose, tubing, or direct connection. A valve (not shown) inside the bottom portion of the insect control device opens when the insect control device may be engaged in treatment mode i.e., receives instructions from the competing device to dispense the insecticide.

In various embodiments, the part of the insect control device 314 under the soil surface 313 may be enabled to administer the insecticide underground using methods selected from but not limited to (i) direct dispensing either under pressure or not under pressure through a nozzle (C) 318, dispensing into a porous reservoir, a tubing, or similar structure for gradual leaching into the soil (B) 320 attached at the end of the controller in one embodiment, and dispensing into a tube or array of tubes which may be laser perforated for gradual leaching into the soil (A) 324, which may be a perforated tubing or reservoir. In one embodiment, (C) 320 is pressurized local dispensation in an area adjacent or nearby the controller 314 base, and B (322) may provide unpressurized seeping style dispensing of the pesticide from the base of the controller 314. It may be appreciated by a person with ordinary skill in the art, in light of and in accordance with the teachings of the present invention, that it may be possible that the dispensing section C, B, or A may be clogged by particulate matter as the portion is inserted in the soil. Accordingly, in one embodiment, if technical difficulties are created by clogging by particulate matter underground it may be ameliorated by using metallic sieves/screens. In one embodiment, a metallic sieve or screen may be fitted around a nozzle head. In other embodiments, the sieve or screen can be fitted over the end of the nozzle to form a protective cocoon or bubble, so that fluid could travel outwards therefrom, but dirt particles would not be able to traverse the bubble or cocoon to avoid clogging. In one embodiment, the system periodically ejects a fluid or air on a scheduled use to prevent build-up or desiccation around the nozzle head. Accordingly, the insecticide may be dispensed from a reservoir that leaches the insecticide into the soil in a relatively small area around the insect control device at B(322), or may be dispensed under pressure through a nozzle structure (C); or may be dispensed through a small network of nozzles laid out in an array or ring around the insect control device or embedded in the insect control device around its circumference such as I (336) in one embodiment.

In one embodiment, the insect control stick may include various sensors for use in sensing one or more characteristics as described hereinabove. In one embodiment, the portion of the insect control stick 314 under the soil surface 313 may include sensors selected from, but not limited to heat sensors (G, 332), which may include thermocouples, use infrared imagery into specialized chambers in the insect control device or immersed in soil, or external such as in a drone that flies over a region protected by the system, for example. In other embodiment, the system can use thermocouples or infrared imagery directly into the soil; moisture sensors (H, 334); other sensors (I, 336) including but not limited to, pH sensors, vibration sensors, and acoustic sensors. The sensor can include time domain spectroscopy (TDS) sensors and supporting structures/interfaces in on embodiment.

In another embodiment, the portion of the insect control device 314 about the soil surface 313 may include sensors selected from, but not limited to, weather sensors (D, 326), including but not limited to sensors for wind speed, temperature, humidity, insolation, and the like; a camera (E, 328) for colorimetric determination of lawn state (green-ness), as well as for visual monitoring of the surface; and a laser (F, 330) for determination of other characteristics of the lawn state, such as the height of the lawn.

In one embodiment, below ground insects like termites and other underground insects may be controlled using chemicals dispensed based on a perforated tubing/drip irrigation tubing, based on a low pressure seepage, or based on a positive pressure discharge characteristics provided by insect control device, based on Time Domain Spectroscopy as detailed below, and the underground insect control system described herein. In one embodiment, above ground insects like mosquitos, roaches, ants and the like may be similarly controlled as the soil is saturated with insecticides, particularly organic repellants discharged using any of the methods described in the instant application.

In another embodiment, a dispenser is operably coupled with the insect control device and with the insecticide reservoir, and wherein the dispenser comprises a nozzle under or not under pressure, a porous reservoir for gradual leaching in the soil, a tube or array of tubes which are perforated for gradual leaching of insecticide in the soil.

In one embodiment, the insect control device 314 may communicate with a computing device (not shown in figure) through a wireless (J) or wired networks. Data collected from the various sensors may be sent to the computing device. The computing device may analyze and integrate the sensor data with other data, including but not limited to real-time weather data, user preferences, historical data for the region, or real-time weather, regulatory, or utility data accessible from an on-line computer, among others, to determine a treatment schedule. The treatment schedule may be sent back to the insect control device via a wireless (K, 340) or a wired connection. The insect control device 314 may then execute the treatment schedule by discharging the insecticide through methods A, B, or C described hereinabove.

In one embodiment, the insect control system described herein may be configured to monitor and provide alerts to users for tank filling, nozzle cleaning, and in one embodiment, performance data on the insect control system may be stored online i.e., in the database, server, or in the computing device. The designated software program may be configured to make automated decisions about when to execute a treatment and how much quantity of insecticide is to be used for the treatment. In certain embodiments, the computing device may be used to adjust and make manual settings via the computing device. FIG. 3C shows an exemplary Time Domain Reflectometry (TDR) sensor. TDR detects water content in soil, and is based on measurement of the propagation velocity of an electromagnetic wave along a transmission line (wave-guide) of length L embedded in the soil. When power is pulsed it takes a time t to reach the end, but t is determined not only by the characteristics of the transmission line but the

$${ɛ}_{b} = {( \frac{c}{v} )}^{2} = {( \frac{ct}{2 L} )}^{2}$$

medium with which it is surrounded: where v=2L/t, ∈_{b} is the soil bulk dielectric constant and c is the velocity of electromagnetic waves in vacuum (3×10⁸ m/s). This equation can be rearranged to show that the time t it takes for the pulse to travel the distance L is proportional to the square root of the dielectric constant of the surrounding media. The dielectric constant of water is 81, but other soil constituents much lower such as soil minerals 3-5, ice 4, and air 1. So, when water is present in the soil, the time it takes the signal to propagate is significantly longer then when no water is present.

One embodiment of TDR would incorporate a dual conductor with a dielectric insulator between the conductors shown in FIG. 3D. The dielectric would be a wood-based material edible for termites and may be wood or wood composite based. It may or may not contain termaticide or materials attractive to termites. As the termites encounter the material during foraging and ingression into an area for which protection is desired, they eat the dielectric material, which would have a higher dielectric constant than soil minerals with or without water (>81), gaps in the material are created and filled with either surrounding soil or air (Figure B). In one embodiment, pulse times from one end of each conductor to the other would then be altered by the reduction in dielectric material along its length and this increase in pulse time would generate a signal that termites are present. In another embodiment, the dielectric material will represent a resistor modulating the amount of current passing from one conductor, held at a positive voltage, to the other grounded conductor. As the dielectric is eaten away, dielectric is replaced with soil and/or air and the resistance increases. The increase in resistance would generate a signal that termites are present. The conductor/dielectric insulator sandwich cable would be buried in the soil, connecting termite sticks sensors distributed around a structure or area to be protected. In this configuration, the termite sticks and connecting conductor/dielectric cables form a protective ring around the structure as shown in FIG. 3E (black line connecting sensors).

When the dielectric constant between any two sensors changes, signals are generated and sent to the controller, which can then initiate termaticide application through a separate circuit (not shown in Figure C). Treatment decisions may be made through an internet cloud-based system, where the controller sends data from the sensors and other sources (e.g. user input) to the cloud, where third-party data can be incorporated to optimize treatment decisions, and signals sent back from the cloud to the controller to initiate treatment.

The wires could be buried alongside the separate subterranean termiticide applicator hose circuit and the chemicals delivered at the precise location the termite presence was detected. The rate of dielectric constant can be monitored and treatment decisions based on changes in this rate. That is, rather than merely the presence of termites, we can base treatment decisions on whether the numbers are increasing. When the dielectric is eaten away, the pulse time or resistance of the cable changes and achieves a new baseline. Rather than replace the cable, the system can be automatically recalibrated to continue monitoring with the same cable. If treatment kills all of the termites, and dielectric material degradation ceases, the cable may last for many additional months or years until the next infestation/treatment. Only if a substantial fraction of the dielectric material is ingested by termites would the cable then need replacing. Other advantages of the method include
a) Detection without gaps—any piercing of the “shield” or “ring” around the area to be protected can be detected.
b) Localization possible—where in the cable the dielectric has been ingested can be determined.
c) Ease of sensing with low levels of power—the method is relatively straightforward, functional on low voltage/power and therefore not only less technically challenging than for example the seismic method, but compatible with alternative energy sources such as photovoltaics.
d) Manufacturability—fabrication of the conductor/dielectric sandwich cables should be relatively straightforward.
e) Affordability—fabrication of the conductor/dielectric sandwich cables should be relatively inexpensive.

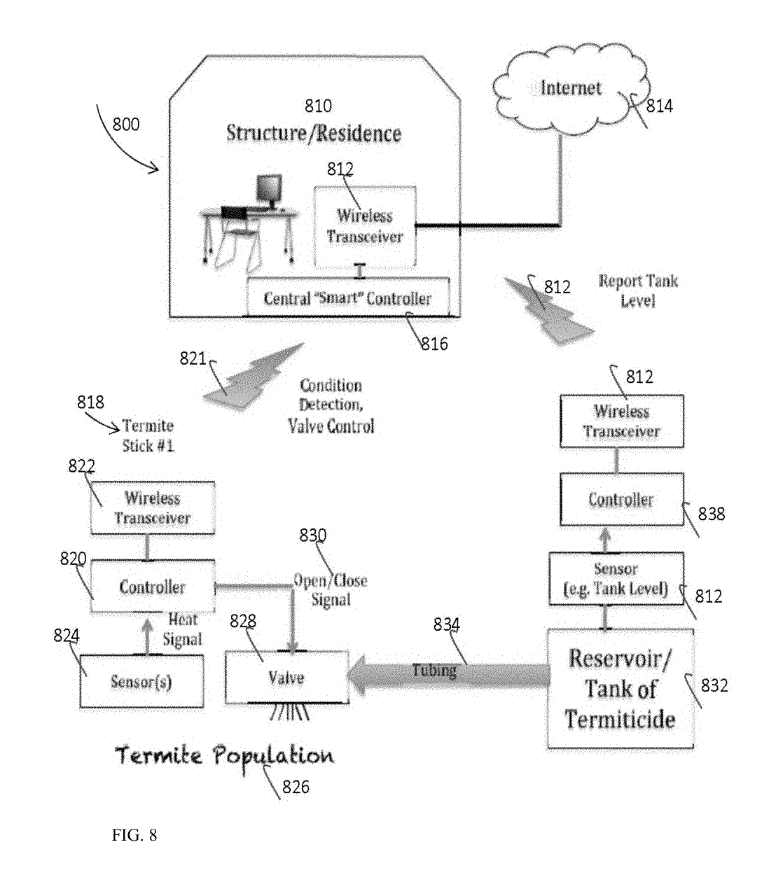

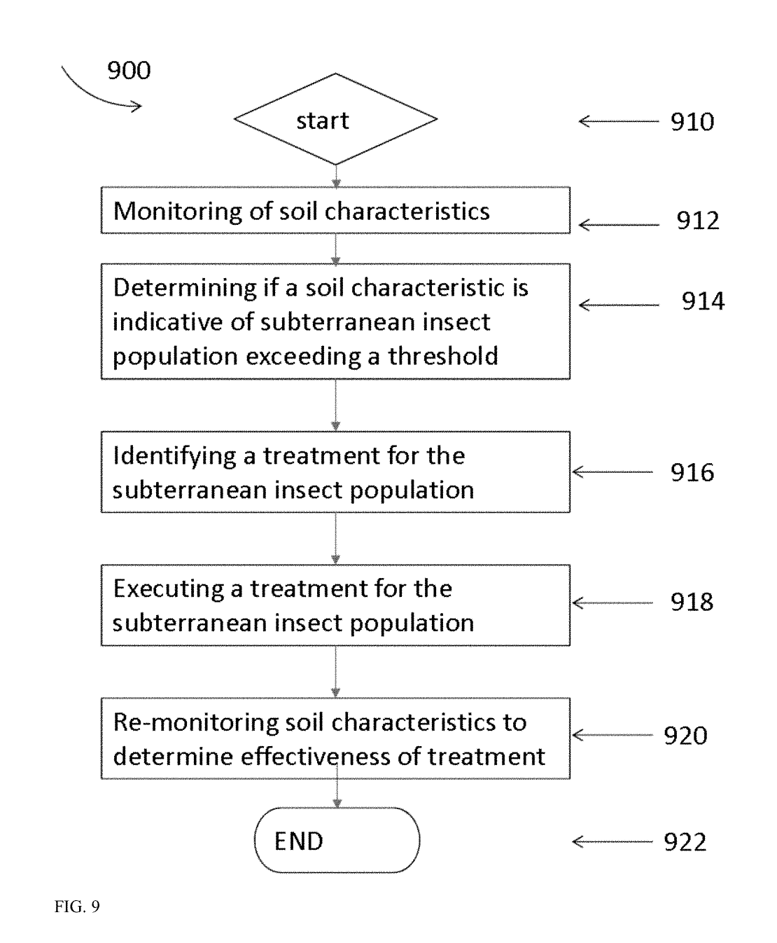

Detection of Subterranean Termites Based on the Monitoring/Sensing/Detecting of a Change in Signals Which Vary Based on a Change in the Value of a Property of a Transmission Line Characterized at Least In Part by a Conductor Cord or Strip Having a Termite-Gnawable and/or Termite-Edible Material. In another embodiment, a sensor or sensor circuit may comprise a conductor cord or strip having one or more conductors and/or a termite-gnawable and/or termite-edible material. The conductor cord is for use in being disposed underground in the soil, perhaps along with the entire sensor or sensor circuit. A transmission line of the sensor circuit is characterized by the conductor cord, as well as by any effecting surrounding elements (e.g. soil or earth, water, or air) in the soil. Here, the sensor or sensor circuit may further comprise a signal generator to produce signals in the conductor cord and a detector to detect changes in the signals. Detection of a subterranean termite population may be made by detecting a substantial or suitable change in the signals which vary based on or in accordance with a change in the value of a property of the transmission line. The property of the transmission line may be a dielectric property, a resistance or impedance property, or both (and/or any other suitable property or properties). The signals may vary based on changes in a transmission line characteristic of the transmission line. A sensor or sensor circuit of the present embodiment may comprise a conductor cord or strip having one or more conductors and/or a termite-gnawable and/or termite-edible material. The conductor cord is for use in being disposed underground in the soil, perhaps along with the entire sensor or sensor circuit. A transmission line of the sensor circuit is characterized by the conductor cord, as well as by any effecting surrounding elements (e.g. soil or earth, water, or air) in the soil. Here, the sensor or sensor circuit may further comprise a signal generator to produce signals in the conductor cord and a detector to detect changes in the signals. Detection of a subterranean termite population may be made by detecting a substantial or suitable change in the signals which vary based on or in accordance with a change in the value of a property of the transmission line. The property of the transmission line may be a dielectric property, a resistance or impedance property, or both (and/or any other suitable property or properties). The signals may vary based on changes in a transmission line characteristic of the transmission line. To illustrate, a conductor cord of FIG. 3C or 3D may comprise dual conductors having a dielectric material/insulator between the conductors. Here, the conductor cord may be or include a termite-gnawable material made from one or more different materials. In one example, the termite-gnawable material may be or include a wood-based material. The wood-based material may comprise one or more wood or wood-composite materials. In one variation, the termite-gnawable material may further comprise or include a termiticide, or other suitable solution, chemical, or substance, which is attractive to termites. The termiticide may be absorbed and carried within the material. In another variation, the dielectric material may not only be termite gnawable and/or termite-edible, but also poisonous or otherwise disruptive to termites. As one example, diflubenzuron may be utilized as a termite-gnawable and/or termite-edible material. When foraging and ingressing into an area, termites will encounter the termite-gnawable material, and gnaw away at and/or eat one or more portions of the material. One or more gaps in the termite-gnawable material may thereby be produced. As a result, there is a physical, structural, mechanical, and/or size reduction of the termite-gnawable material. Viewing an example result, FIG. 8 28 reveals a (modified) conductor cord 800 with portions of the termite-gnawable material gnawed away, eaten, and/or missing. The gaps in the material may be filled with surrounding soil, air, or both (and/or other). During system operation, one or more electrical signals (e.g. one or more pulse signals) may be produced or generated in the conductor cord, e.g. on a regular or repeated basis. Accordingly, the time T that it takes for the signals to travel in the conductor cord from one end to the other end may change based on and/or in accordance with the change (e.g. reduction) in the value of the dielectric property. A substantial or other suitable change (e.g. an increase) in the time T that the signals travel may result, which may be an indication that termites are present. In this or other similar manner, it may be determined whether sensor characteristics in one or more of the underground soil regions are indicative of a subterranean termite population exceeding a threshold. The termite-gnawable material(s) of the conductor cord or strip may be selected in advance of use to be one having a dielectric property with any suitable dielectric constant. A dielectric constant may be said to be a number denoting the ability of a material to resist the flow of electric current through it. Note that the termite-gnawable material(s) of the conductor cord may be selected in advance of use to be one having a dielectric property with any suitable dielectric constant that falls within a set range of suitable dielectric constants. The selection of the termite gnawable material(s) having the suitable dielectric constant may be based on at least the value(s) of the dielectric constant(s) of the surrounding soil material(s) and/or possibilities thereof, the value(s) of the dielectric constant(s) of any surrounding water/rain and/or possibilities thereof, and/or the value(s) of the dielectric constant(s) of any surrounding termiticide and/or possibilities thereof. In general, the termite-gnawable material(s) may have a dielectric constant that is generally greater than the surrounding soil (e.g. with or without water present). The dielectric constant of soil or soil constituents, such as common soil minerals, may be relatively low, at between about 3-5. On the other hand, the dielectric constant of any surrounding water is relatively high, at about 81. Based on the known data, a suitable selection of a dielectric constant and/or material(s) may be made. Air has a dielectric constant of 1, and water has a dielectric constant of 80. Thus, one suitable termite-gnawable material and/or termite-edible material may have a dielectric constant within a set range of between 1 and 80. Of course, when such a material is eaten, it will be replaced by either air or water (moist soil). Thus, a termite-gnawable material and/or termite-edible material having a dielectric constant of 40 may be suitable, since it carries much different properties than air or soil. 30 As another example, another set range of values may be 50-60. Yet another example is a set range of values which is 60-70. In one or many possible variations, the termite-gnawing and/or termite-edible material of the conductor cord or strip may have a resistance which varies the amount of current passing from one conductor (e.g. held at a positive voltage) to another (e.g. grounded) conductor. As the material is gnawed away, the material is replaced with soil and/or air and the resistance changes (e.g. increases). This change (e.g. increase) in resistance may produce a signal to indicate the existence of a subterranean termite population that exceeds a threshold. The conductor cord or strip may be for use in inserting, disposing, and/or burying in the soil. One or more such conductor cords may be carried on connecting termite sticks sensors, distributed around a structure or area to be protected. In such a configuration, the termite sticks and connecting conductor cords may form a protective ring around a structure 900 (e.g. a residence) as shown in FIG. 9 (black line connecting sensors). When the dielectric constant between any two sensors changes, signals are generated and sent to the controller, which can then initiate termiticide application through a separate circuit. Treatment decisions may be made through an internet cloud-based system, where the controller sends data from the sensors and other sources (e.g. user input) to the cloud, where third-party data can be incorporated to optimize treatment decisions, and signals sent back from the cloud to the controller to initiate treatment. The wires could be buried alongside the separate subterranean termiticide applicator hose circuit and the chemicals delivered at the precise location the termite presence was detected. The rate of dielectric constant can be monitored and treatment decisions based on changes in this rate. Treatment decisions may be made based on detecting the presence of termites. Further, treatment decisions may be based on whether the numbers are increasing. When the dielectric is eaten away, the pulse time or resistance of the cable changes and achieves a new baseline. Rather than replace the cable, the system can be automatically recalibrated to continue monitoring with the same cable. If treatment kills all of the termites, and dielectric material degradation ceases, the cable may last for many additional months or years until the next infestation/treatment. Only if a substantial fraction of the dielectric material is ingested by termites would the cable then need replacing.

The best dielectric material would be those with a dielectric constant between 1 and 80—air has a constant of 1 and water has a constant of 80, and when the dielectric constant we use to detect is eaten away it will be replaced by either air or water (moist soil). A constant of 40 would be optimal since it can easily be distinguished from air or soil.

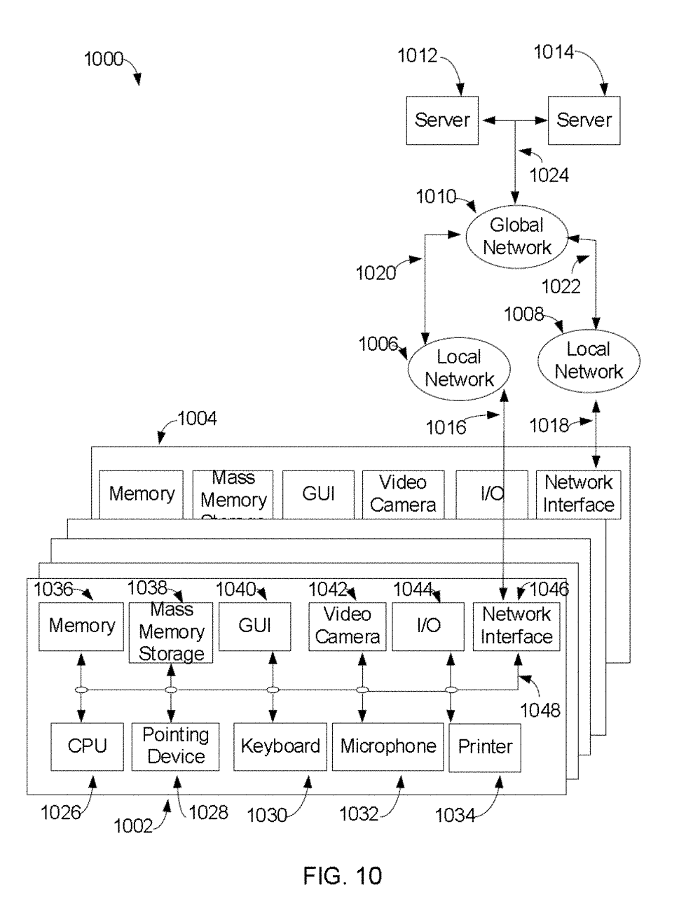

FIG. 3F is an illustration of another example of a system configuration 1000 which makes use of one or more sensor circuits comprising one or more conductor cords or strips including a termite-gnawable material. A structure 1002 to protect, such as a residence, a garage, or tree, is shown. A plurality of termite sticks (e.g. a stick 1004) and a plurality of conductor cords (e.g. a conductor cord 1010) are disposed in a ring configuration underground within the soil around the structure 1002. Each stick 1004 may include or carry circuitry such as a signal generator 1006 and a detector 1008, circuitry which is associated with a corresponding conductor cord 1010. Note, however, that a single signal generator 1006 and detector 1008 pair may be associated with two or more conductor cords. A method of installing the system configuration 1000 of FIG. 10 in relation to the structure 1002 may be as follows: (1) excavating or digging or forming a trench or a slit in the soil at least partially around the structure to be protected; (2) providing at least one sensor or sensor circuit including a conductor cord or strip comprising a termite-gnawable and/or termite-edible material; (3) disposing the conductor cord or strip in the trench or slit, at least partially around the structure to be protected; and (4) activating the sensor circuit for operation (e.g. the sensor circuit may further include a signal generator to produce signals in the conductor cord and/or a detector to detect changes in the signals). A transmission line of the sensor circuit is characterized by conductors of the conductor cord, as well as by any effecting surrounding elements (e.g. soil or earth, water, or air) in the soil. Detection of a subterranean termite population may be made by detecting a substantial or suitable change in the signals which vary based on or in accordance with a change in the value of a property of the transmission line. The property of the transmission line may be a dielectric property, a resistance or impedance property, or both (and/or any other suitable property or properties). The signals may vary based on changes in a transmission line characteristic of the transmission line. Advantages of this method include: (a) detection without gaps—any piercing of the “shield” or “ring” around the area to be protected can be detected; (b) localization possible—where in the cable the dielectric has been ingested can be determined; (c) ease of sensing with low levels of power—the method is relatively straightforward, functional on low voltage/power and therefore not only less technically challenging than for example the seismic method, but compatible with alternative energy sources such as photovoltaics; (d) Manufacturability—fabrication of the conductor/dielectric sandwich cables should be relatively straightforward; (e) affordability—fabrication of the conductor/dielectric sandwich cables should be relatively inexpensive.

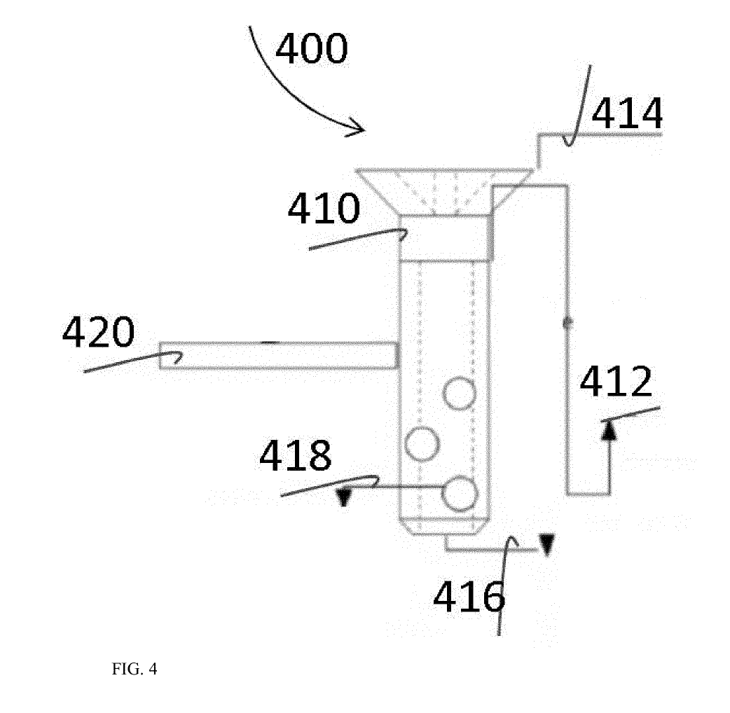

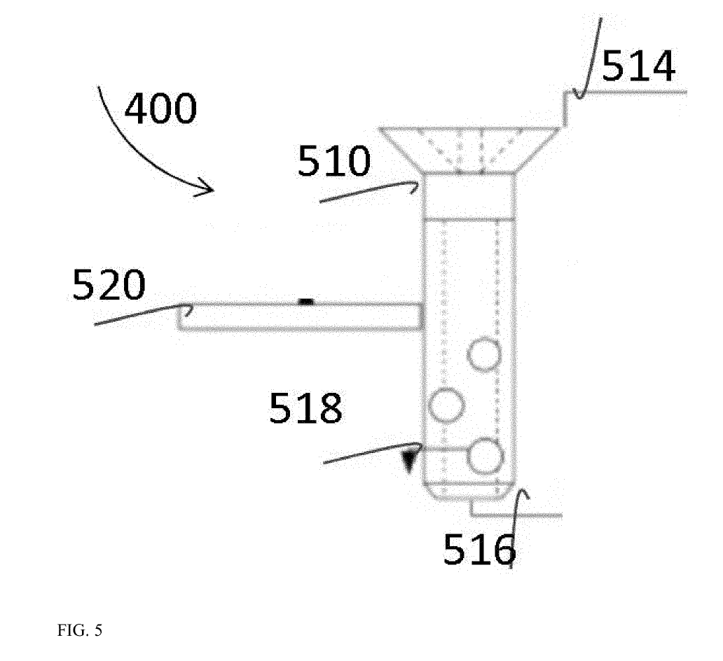

Referring to FIG. 4 and FIG. 5, are provided perspective views illustrating an exemplary insect control device, in accordance with an embodiment of the present invention. FIG. 4 illustrates an insect control device 410 including a reservoir 412. FIG. 5 illustrates an insect control device 510 without a reservoir. As shown in the exemplary embodiments illustrated in FIG. 4 and FIG. 5, the insect control device 410, 510 may be designed to have a shorter and stouter appearance. The insect control device 410, 510 may include above ground sensors 414, 514 located at the top of the insect control device in the portion above the soil level. The above ground sensors 414, 514 may include weather station sensors for monitoring including but not limited to wind, humidity, precipitation, shade level, line of sight sensor alert user to cut the grass, and the like. The above ground portion of the insect control device 410, 510 may also include Wi-Fi capability to communicate the monitored data to a computing device for further action. The insect control device 410, 510 may include below ground sensors 416, 516 located at the bottom of the insect control device in the portion below the soil level. The below ground sensors 416, 516 may include sensors for [ADD—TIME DOMAIN SPECTROSCOPY OR TDS], thermal, moisture, pH level, and for detection of minerals such as phosphorus, potassium, calcium, magnesium, sodium, sulfur, manganese, copper, zinc, and the like. In one embodiment, in both designs 400, 500, the insect control device 410, 510 may be plumbed into a stand-alone piping system from a centralized tank. In one embodiment, in both designs 400, 500, the insect control device 410, 510, may be plumbed into an existing sprinkler irrigation system for surface application of insecticide from distributed termite stick specific tanks. In the embodiment with the stand-alone, separate piping system (distinct from existing irrigation/sprinkler system), the insecticide may be housed in a centralized tank and may be pumped through a piping system, and into each insect control device, and then out of the insect control device outlets 418, 518 into the surrounding soil, regulated by valves provided in the insect control device 410, 510. In one embodiment, the opening and closing of valves may be automatically controlled by the computing device depending on when, where, and how much insecticide must be dispensed. In one embodiment, a separate controller may be employed with a network of insect control devices for regulating the valves.

Accordingly, the insect control system described herein may be useful for minimizing or eradication insects both above ground level and below ground level. For above ground pests, like sensors may be in the form of boxes which may or may not use bait (general or insect specific) and the occlusion of laser, optical, electrical, or dielectric bait signals to register insect presence. The above ground level sensors boxes may be termed as electronic bait traps (EBTs). For example, for mosquitos, EBTs could be hung from trees or shrubs, placed on roofs, or window sills, and like our TDS termite sensors, they may communicate their findings with our control box via wireless (Wi-Fi or other radio signal) means.

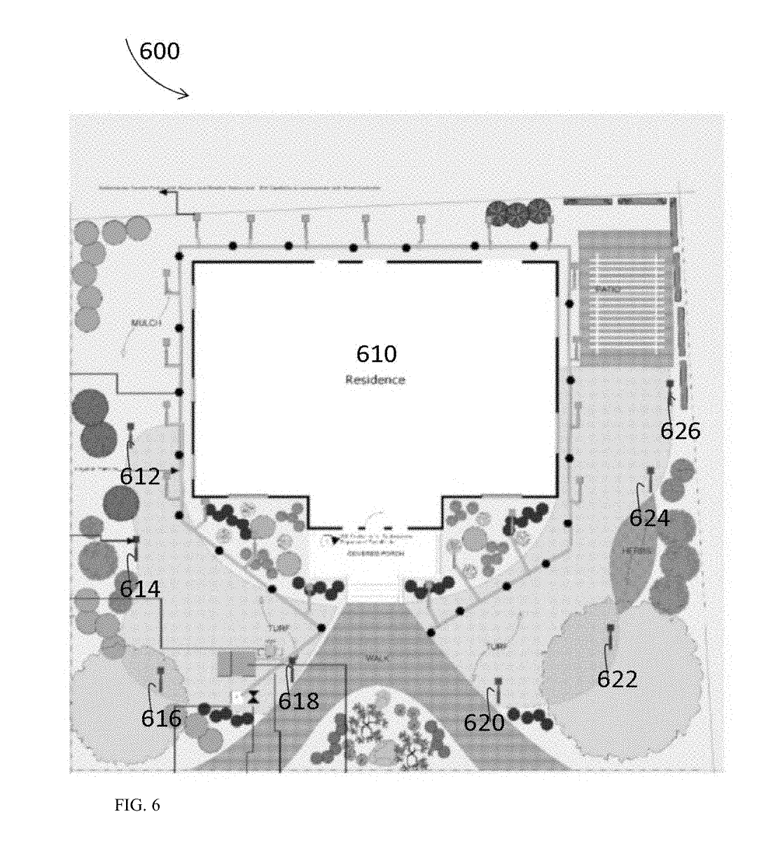

Referring to FIG. 6, is provided a perspective view 600 illustrating a system for insect control including a typical layout of insect control devices for a typical residence, in accordance with an embodiment of the present invention. As shown in FIG. 6, a typical layout of insect control devices, for a typical residence 610 is provided. In an exemplary embodiment, a plurality of insect control devices shown in FIG. 5 i.e., without a tank connected to the insect control device, to form a semicircular protective ring. The insect control devices 612, 614, 616, 618, 620, 622, 624, and 626 shown in FIG. 6 may serve as a sensor package, without dispenser capability. In one embodiment, a tank containing insecticide, organic pesticide and organic fertilizer is plumbed directly into a surface sprinkler irrigation system. A valve between the tank pump and the irrigation system is controlled by the computing device. As mentioned hereinabove, the computing device includes a designated computer program to make a determination based on the data provided by the insect control sticks via Wi-Fi connection. In one embodiment, the layout/system described in FIG. 6 may be applicable for surface insecticide application by employing a pre-existing sprinkler system.

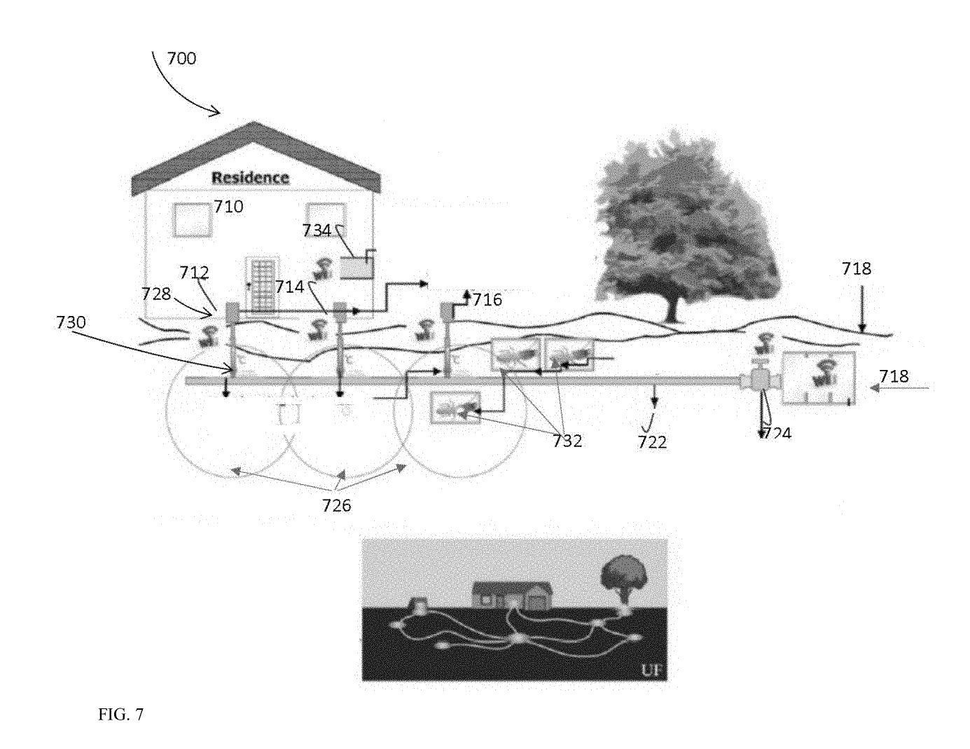

Referring to FIG. 7 is provided a perspective view illustrating a system for insect control including a typical layout of insect control devices for a typical residence, in accordance with an embodiment of the present invention. As shown in FIG. 7, a typical layout of insect control devices, for a typical residence 710 is provided. In an exemplary embodiment, a plurality of insect control devices 712, 714, 716 shown in FIG. 4 i.e., with a tank 720 connected to the insect control device are used. The insect control devices may be partially embedded below the soil surface 718. The insect control devices 712, 714, and 716 in this exemplary embodiment may represent not only sensor packages, but also dispensers or valves for regulating above and/or below ground release of insecticide. The portion of the insect control devices 728 above the ground level 718 may include weather station sensors and line of sight sensor. The portion of the insect control devices 730 below the ground level 718 may include heat and moisture sensors. A dedicated piping system 722 with valves 724 may be provided that connect the insect control devices 712, 714, 716 to a tank 720. In one embodiment, the reservoir 720 may include three compartments—one for insecticide, one for organic fertilizer, and one for organic pesticide. The insect control devices may include valves that may be opened and closed using wi-fi signals from the computing device 734, regulate the passage of termiticide, pesticide, and/or fertilizer through the insect control devices for either surface or underground discharge to control subterranean insects 732. The decision of which insect control device is discharging, and whether the discharge may be surface and/or underground may be made by the computing device 734. As discussed hereinabove, the computing device 734 may comprise a designated computer program which integrates sensor data on ambient pest/soil conditions, atmospheric conditions from both the insect control devices and forecast data from the internet and user preferences to provide an appropriate decision on what insecticide, which region, what quantity, what flow rate, and the like.

In one embodiment, the insect control devices 712, 714, 716 may be so positioned that the range of detection for the sensors in each insect control device 712, 714, 716 may overlap 726 to form a continuous detection ring around the structure, for example, residence 710. Accordingly, in an exemplary embodiment, for underground application of insecticide, if the dispense approach (nozzle type, or discharge chamber size/pressure) is optimized for covering several tens of feet of soil diameter around the base of the insect control device, the dispensed insecticide may form an overlapping and continuous ring of protection around the structure.

In another embodiment, the insect control devices may be employed as gatekeepers for a physical, not just chemical. For example, the devices can be part of a perma-barrier or permanent, ever present barrier to form a moat-like system against termites. With the approach shown in FIGS. 6 and 7, the insecticide, pesticide, or fertilizer may be released from the insect control device and form a protective barrier. Accordingly, continuous chemical barrier may be provided around a structure using a proper layout and positioning of the insect control devices.

In another embodiment, a physical barrier may be formed around a structure. In this exemplary embodiment, the insect control devise may serve the same basic role i.e., where sensors may be used to measure when insecticide is needed resulting in the dispense of insecticide, however in this embodiment, the insecticide may be pumped into a tubing system that encircles a structure that may potentially suffer damage from insects. The tubing may be porous or microporous, created using laser or mechanical perforation for the weeping or leakage of insecticide from inside the tubing to the soil environment outside the tubing. It may be appreciated by a person with ordinary skill in the art, in light of and in accordance with the teachings of the present invention that such tubing may be similar to that commonly employed for drip irrigation, and may be buried from a few inches to a few feet below the soil surface, and effectively serve as a physical moat forming a continuous protective ring (either in the form of a semicircle or complete circle) of protection around the home/structure. The pressure of termiticide inside the tubing and flow rate, may dictate the amount and timing of treatment, and be regulated by the computing system based on either ambient needs, projected needs or with respect to a particular treatment schedule. This method may be advantageous in that the insecticide released may ensure that a continuous protective ring is present around the structure and avoid any arbitrariness in an insecticide ring formation around the structure being protected, that may arise from soil absorption dynamics.

In one embodiment, the insect control device may also be able to line of sight with other insect control devices to provide a measurement on the height of grass in a lawn. Once the grass grows to a certain height, for example, St. Augustine grass 5 inches in height, the insect control device may alert the customer and/or the landscape company that the grass may need cutting by about an inch. It may be appreciated by a person with ordinary skill in the art, in light of and in accordance with the teachings of the present invention that, for healthy lawns it may be needed to cut certain grass at a certain height to avoid any diseases and/or insect attacks.

In one embodiment, the insect control device may measure the soil chemistry underground. Soil testing on a regular basis by the termite sticks, using various sensors such as conductivity sensors, may alert the customer and/or lawn and landscape company of the fertilization needs of the soil. The insect control device may test for pH level (alkalinity), conductivity, and select elements such as phosphorus, potassium, calcium, magnesium, sodium, sulfur, manganese, copper, and zinc using commonly available selective chemical sensors. The results may be reported back to the computing device, via Wi-Fi or over a wired connection, and the customer and/or lawn and landscape company are alerted if levels indicate that fertilization is needed, and if irrigation is needed, for example, either above or below ground level.

In one embodiment, the insect control device may include a power supply that maybe wired to the main power supply of the structure. In one embodiment, the insect control device may be powered by a solar cell and a solar-charged battery. In certain embodiments, the insect control device may also incorporate an LED light for decorative purposes, as well as to indicate where the termite stick is protruding from the ground. In certain embodiments, the top of the insect control device may be fashioned as a landscape rock, a flower pot, or even a plant to conceal the insect control device.

A working example of the insect control system may include at least one insect control device described in FIGS. 4, 5, and 6, with a dedicated piping system from a tripartite tank. The Wi-Fi enabled computing device may be in communication with a home-based internet connection either using wired or wireless connection for retrieving weather forecast information. The weather forecast may be for rain in the next three days followed by a dry spell. The computing device may be fed information from the insect control device sensor package which may report that three of the installed insect control devices in a twelve-insect control device network may be reporting unusually high underground temperatures measured by the thermocouple in the insect control device, and confirmed by the infrared imaging in the insect control device, which may indicate the presence of insects. The sensors may also indicate an alkaline pH possibly indicating the release of uric acid, also potentially indicative of insect activity, vibration of a frequency compatible with insect mandible probing. The sensor package may also report to the computing device that the soil is dry, indicating there may be good absorption and capillary pull for applied insecticide. Through the designated software program, the user may indicate that a treatment may be applied when the system for insect control may determine it is necessary and appropriate. The computing device in the system for insect control may determine that insecticide treatment may be necessary in the region of the three identified insect control devices, plus one on either side as insurance, and that the best time to treat may be two days after the rain ends and in the early evening hours. The computing device may also determine based on the sensor and prediction data that treatment should be underground, and that soil conditions are not appropriate for fertilizer application and that regularly scheduled surface pesticide treatment is not due. Furthermore, the user has St. Augustine grass in the lawn, and the information in the computing device shows that this grass is known to grow well in nearly all soil types and is tolerant to shade, heat and to some degree drought, and depending on the ambient conditions, usually requires watering every 5-10 days to maintain a dull, bluish color with rolled or folded leaves and persistent footprints. Based on the slope of the user's lawn, the weather forecast, and the type of grass the computing device may determine the time the insecticide treatment may be warranted, for example, insecticide to be dispensed in five days, and no surface or subsurface irrigation may be necessary or useful. In one embodiment, multiple email alerts may be generated, and a graphic chart for animation of treatment plans, chemical levels and sensor data including the precipitation/weather forecast may be provided to the user. Five days later, the system may go into application mode. The computing device may determine the saturation factor for the level of the insecticide in the tank. According to the saturation factor measurements the designated software program in the computing device may calibrate the designated software program in the dispense unit/valves, to automatically dispense the right amount of insecticide that needs to be fed into the ground through the identified insect control device. For example, the computing device may thus determine that the valve is to remain open for about thirty minutes, and the pump is to maintain a determined pressure of about ten PSI to provide the insecticide with necessary soil penetration, form a “ring” of protection around each insect control device to achieve a continuously treated area covering all five of the termite sticks, within legal limits for the insecticide used. The computing devices may send a wi-fi signal to the five insect control devices for the dispensation, the pump may be activated, and the underground application valves may be opened in or near each of the five-insect control device. After about thirty minutes, the valve may be closed and the pump may be shut off on receiving a wi-fi signal form the computing device. Sensors in the reservoir may alert the pest control service provider that the insecticide compartment needs topping off. In addition, the above ground digital camera and laser grass height monitor may alert the user that lawn cutting is needed within the next seven days. Five days after the rains end and three days after the insect control device have treated the infested soil, the sensor package may register that the heat levels, pH levels and acoustic levels below ground in the area of the five insect control devices have all reached normal levels and no further treatment is recommended or executed.

In one embodiment, the system for insect control may be utilized for underground irrigation where instead of insecticide the insect control device may be used to release water at a depth in the soil. The insect control devices may also be connected to the pre-existing sprinkler systems to achieve surface irrigation. Irrigation below ground may be potentially useful because roots are below ground, and irrigation serves strictly to hydrate root systems. Irrigating underground keeps the soil moist longer because the water is placed directly where needed—near the roots—and more of the water dispensed is actually used rather than wasted. Overall less water may be used when employing this system.

In one embodiment, the sensor package and dispenser (nozzle) may be encapsulated into a single package for precise point-of-care sensing and treatment. The system is focused on the need to protect a residence from insects, more than the need to maintain a lush lawn. Accordingly, all decisions made by the computing system factor the protection of the home from insect as top priority. If the insect problems are bad and recurring, for example, even during the summer months, and the system for insect control may decide not to irrigate but to only chem-irrigate, and the lawn health may suffer temporarily.

It may be appreciated by a person with ordinary skill in the art, in light of and in accordance with the teachings of the present invention that, the detection of air pockets or tunnels created by subterranean insects based on the monitoring/sensing of seismic-type, sound, bibrational, and/or acoustic waves, and the like may be carried out by any known method. In one embodiment, a type of reflection seismology, for example, technology utilized largely in the oil and gas industry, for the detection of air pockets, holes, or tunnels created by subterranean termite populations may be employed. As referred to herein, reflection seismology (or seismic reflection) may be characterized as a method of exploration geophysics that uses the principles of seismology to estimate the properties of Earth's subsurface from reflected seismic waves. The method employs a controlled seismic source of energy. Reflection seismology is similar to sonar and echolocation. Seismic waves are mechanical perturbations that travel in the Earth at a speed governed by the acoustic impedance of the medium in which they are travelling. The acoustic (or seismic) impedance, Z, is defined by the equation:

Z=Vρ,

where V is the seismic wave velocity and ρ (Greek rho) is the density of the rock.

When a seismic wave travelling through the Earth encounters an interface between two materials having different acoustic impedances, some of the wave energy will reflect off the interface and some will refract through the interface. The seismic reflection technique may involve generating seismic waves and measuring the time taken for the waves to travel from the source, reflect off an interface, and be detected by an array of receivers (or geophones). Knowing the travel times from the source to various receivers, and the velocity of the seismic waves, the pathways of the waves are reconstructed in order to build up an image.

In the case of subterranean insect detection, an interface between the soil and an air pocket, hole, or tunnel (e.g., air) created by a subterranean insect population may be made. Accordingly, the detection or identification of such a tunnel is a detection or identification indicative of a subterranean insect population.

In common with other geophysical methods, reflection seismology may be viewed as a type of inverse problem. That is, given a set of collected data and applicable physical laws, an abstract model may be developed of the physical system being studied. In the case of reflection seismology, the data are recorded seismograms, and the desired result is a model of the structure and physical properties of the Earth. In common with other types of inverse problems, the results obtained from reflection seismology are usually not unique (more than one model adequately fits the data) and may be sensitive to relatively small errors in data collection, processing, or analysis.

A principle of seismic reflection is to send out waves (e.g., elastic waves) with an energy source into the Earth, where each layer within the Earth reflects a portion of the wave's energy back and allows the rest to refract through. The reflected energy waves are recorded over a predetermined time period, which may be called the record length, by receivers that detect the motion of the ground in which they are placed. On land, one typical receiver used is a small, portable instrument known as a geophone, which converts ground motion into an analog electrical signal. Each receiver's response to a single shot is known as a “trace” and is recorded in storage. The shot location may then be moved along and the process repeated. Typically, the recorded signals are subjected to significant amounts of signal processing before they are ready to be interpreted. When a seismic wave encounters a boundary between two materials with different acoustic impedances, some of the energy in the wave will be reflected at the boundary while some of the energy will be transmitted through the boundary. Again, in the case of subterranean termite detection, an interface between the soil and an air pocket, hole, or tunnel (e.g. air) created by a subterranean termite population may be made. The amplitude of the reflected wave is predicted by multiplying the amplitude of the incident wave by the seismic reflection coefficient ‘R’, determined by the impedance contrast between the two materials.

For a wave that hits a boundary at normal incidence (head-on), the expression for the reflection coefficient is simply

$$R = \frac{( {Z}_{1} + {Z}_{0} )}{( {Z}_{1} + {Z}_{0} )} ,$$

where Z₀ and Z₁ are the impedance of the first and second medium, respectively. Similarly, the amplitude of the incident wave is multiplied by the transmission coefficient to predict the amplitude of the wave transmitted through the boundary. The formula for the normal-incidence transmission coefficient is

$$T = \frac{2 {Z}_{0} {Z}_{1}}{( {Z}_{1} + {Z}_{0} )}$$

As the sum of the squares of amplitudes of the reflected and transmitted wave has to be equal to the square of amplitude of the incident wave, it may be shown that

$$1 - {R}^{2} = \frac{{( {Z}_{1} + {Z}_{0} )}^{2} - {( {Z}_{1} - {Z}_{0} )}^{2}}{{( {Z}_{1} + {Z}_{0} )}^{2}} = \frac{4 {Z}_{0} {Z}_{1}}{{( {Z}_{1} + {Z}_{0} )}^{2}} = {T}^{2}$$

By observing changes in the strength of reflectors, changes in the seismic impedances may be identified or inferred. In turn, this information may be used to identify or infer changes in the properties of rocks at the interface, such as the density and elastic modulus. The time it takes for a reflection from a particular boundary to arrive at the geophone is called the travel time. If the seismic wave velocity in the rock is known, then the travel time may be used to estimate the depth to the reflector. For a simple vertically traveling wave, the travel time t from the surface to the reflector and back is called the Two-Way Time (TWT) and is given by the formula

$$t = 2 \frac{d}{V}$$

where d is the depth of the reflector and V is the wave velocity in the rock.

A series of apparently related reflections on several seismograms is often referred to as a reflection event. By correlating reflection events, an estimated cross-section of the geologic structure that generated the reflections may be created. Again, this type of wave sensing may be utilized to distinguish between the soil and an air pocket, hole, or tunnel (e.g. air) created by a subterranean insect population. Accordingly, the detection or identification of such an air pocket or tunnel is a detection or identification indicative of a subterranean insect population. The shape, length, and/or size of such a tunnel may be taken in consideration in detection or identification. The techniques described above in relation to the figures may be employed in the same or similar manner as described, but with use of such wave sensing.

In an exemplary embodiment, an insect control device may be considered as a central source and may be configured to send waves underground, where a plurality of other insect control devices may be configured to receive and report the reflected waves in response (e.g., regularly or periodically). In another exemplary embodiment, a plurality of insect control devices may be configured to send waves and a plurality of other insect control devices may be configured to receive waves. In yet another exemplary embodiment, each insect control device may be configured to both send waves to a corresponding insect control device and receive waves from another corresponding insect control device.

In certain embodiments, sensing of radio frequency (RF) waves, electromagnetic waves, ultra-sonic waves, or infrared waves may be utilized as alternatives for deriding subterranean insect population.

In one embodiment, the detection of subterranean insects may be done based on the monitoring/sensing of sounds, acoustics, or vibrations produced by the subterranean insects. It may be appreciated by a person with ordinary skill in the art, in light of and in accordance with the teachings of the present invention that, the sound or acoustics produced by a subterranean termite population is unique, i.e., subterranean insects, for example subterranean termites, have unique frequency characteristics, sound durations, and/or sound patterns, and therefore they may be distinguished from other noise or signals or sources. Note that, individually, the sound level of one or more termites may be relatively low, however collectively the sound level of a subterranean termite population may be large and exceed a certain threshold. A treatment need may be identified based on the level or amplitude of the sound/acoustics, and/or the frequency or duration or pattern of the sound/acoustics. In this embodiment, a suitable sensor, such as a microphone, an acoustic sensor, a geophone, an accelerometer, a piezoelectric transducer, or an ultrasonic sensor, as examples, may be utilized in each insect control device. An amplifier and/or filter may also be employed at each insect control device and/or the computing device. Any suitable frequencies or frequency range(s), and/or other suitable characteristics, of the signals which may be generated by the insects may be monitored. Suitable signal processing and/or software may be employed as appropriate. In one embodiment, the frequencies or frequency range(s), or other characteristics, may be remotely tunable and/or programmable. For example, the one or more filters employed may be tunable. This tunability/programmability may be useful since continued research of the appropriate characteristics may be ongoing, and depend on the species and/or types of pests to identify. The first computing device, through its wireless transceiver, may remotely program a second computing device provided at each insect control device to update or add to such information.

In certain embodiments, a microphone or acoustic sensor may be employed above-ground level, to identify above-ground noise signals. The real-time above-ground noise signals or characteristics may be identified and sent wirelessly to the computing devices at the insect control device, and/or to the computing device, for use in filtering such noise from the underground sound/acoustic signals, for example, the insect sounds.

In certain embodiments, alternatives to insecticide and the insecticide tank may be employed for eradication or minimizing the insect population. In one embodiment, transmission of sound/acoustic waves may be used as the treatment. Accordingly, in one embodiment, when a treatment need is identified, a sound or vibrational wave or signal may be produced at one or more frequencies known to control a subterranean termite population, for example, a sound frequency that may cause the termites to scatter or retreat over one or more time periods. Any suitable frequencies may be utilized, for e.g. from 5 Hz to 5 kHz. Any suitable sound transmission element (e.g. speaker device) may be utilized to produce the sound frequency, for example, a super-magnetostrictive element may be employed. Such elements may be utilized at each termite stick, commanded by the computing system via the wireless transceiver. In other embodiments, an electromagnetic wave or signal, a radio frequency (RF) wave or signal, an ultrasonic wave or signal, etc. . . . known to cause termites to scatter or retreat may be produced

It may be appreciated by a person with ordinary skill in the art, in light of and in accordance with the teachings of the present invention that any suitable frequencies or frequency range(s), and/or other suitable characteristics, of the emitted signals which may control the termites may be utilized. These frequencies or frequency range(s), or other characteristics, may be remotely tunable and/or programmable. This tunability/programmability may be useful since continued research of the appropriate control characteristics may be ongoing, and depend on the species and/or types of pests to control. The computing device, through its wireless transceiver, may remotely program the computing device provided at each insect control device to update or add to such information.

In an alternative embodiment, sound/acoustic or other waves may be employed for attracting termites. For example, such a signal may be emitted to attract the subterranean insect population closer to a sensor (e.g. any one of the insect control device) for better detection, and/or closer to an insecticide dispenser or other treatment device for treatment. Any suitable sound transmission element at any suitable frequency may be utilized. For example, a super-magnetostrictive element may be employed. Such elements may be attached to or carried on each insect control device, being collocated with the sensor(s) and/or dispensers. In an alternative embodiment, an electromagnetic wave or signal, a radio frequency (RF) wave or signal, an ultrasonic wave or signal, etc. . . . known to attract or cause termites to draw closer may be employed.

It may be appreciated by a person with ordinary skill in the art, in light of and in accordance with the teachings of the present invention that any suitable frequencies or frequency range(s), and/or other suitable characteristics, of the emitted signals which may control the termites may be utilized. These frequencies or frequency range(s), or other characteristics, may be remotely tunable and/or programmable. This tunability/programmability may be useful since continued research of the appropriate control characteristics may be ongoing, and depend on the species and/or types of pests to control. The computing device, through its wireless transceiver, may remotely program the computing device provided at each insect control device to update or add to such information.

Referring ahead to FIG. 8, is illustrated a block diagram providing a method 800 for insect control in accordance with an embodiment of the present invention is shown. A structure/residence 810 is surrounded by a lawn, where underground in the soil beneath the lawn a subterranean termite problem may exist. A wireless transceiver 182 of the residence may be connected for internet access service 814. The wireless transceiver 812 may be a wireless access point for Wi-Fi access. It may be appreciated by a person with ordinary skill in the art, in light of and in accordance with the teachings of the present invention that, other suitable wireless network technologies may be employed. The wireless transceiver may be connected to a first computing device 816.

A plurality of insect control devices i.e., termite sticks, may be positioned around the residence 810, each being inserted at least partially underground. Each termite stick, one of which is shown in FIG. 8, 818, may include a second computing device 820, for example, a microcontroller, a microprocessor, or the like, including the designated computer program, and a wireless transceiver 822 for communication with the first computing device 816 via the wireless transceiver 812 of the residence 810.

Each termite stick may include one or more sensors 824 which may be disposed underground and used to detect one or more underground soil characteristics, for example, thermal heat or moisture level characteristics; seismic-type, vibrational, or acoustic characteristics indicative of air pockets or tunnels created by a subterranean termite population; or sound or acoustic levels produced by a subterranean termite population 826. The characteristics may be reported 821 via the wireless transceiver 822 to the first computing device 816 regularly, periodically, or when a predetermined characteristic is detected (e.g., the level reaches a predetermined threshold). The first computing device 816 may determine whether a subterranean termite population is above a threshold based on the detected characteristics, perhaps in combination with other characteristics as described herein above. The termite stick 818 may be connected to a valve 828. Depending on the instructions provided by the first computing device 816, the second computing device 820 may provide the valve with a signal 830 for opening or closing, i.e., to start dispensing or stop dispensing the termiticide. A tank 832 may be connected using tubing 834 to the termite stick 818 via the valve 828. The tank 832 may be operably coupled with a sensor 836 for detecting level of insecticide in the tank. The sensor 836 may be operably coupled with a third computing device 838 and the third computing device may be operably coupled with a wireless transceiver 840 for communicating the level of insecticide in the tank 832 to the first computing device m816.

Referring to FIG. 9 is provided a flow chart illustrating a method for insect control in accordance with an embodiment of the present invention. The method starts with a first step 910. In the first step 910 the insect control system as described at least in FIG. 8 may be set up at or near a residence. In a second step 912 the method may include monitoring of soil characteristics in a plurality of underground soil regions. The soil characteristics may include, but may not be limited to, thermal i.e., heat characteristics, moisture characteristics; seismic-type, vibrational, dielectric constant characteristics (in farads, for example), or acoustic characteristics indicative of air pockets or tunnels created by a subterranean insect population; and sound or acoustic levels produced by a subterranean insect population. In a third step 914 the method may include determining whether one or more of the soil characteristics in one or more of the underground soil regions are indicative of a subterranean insect population exceeding a threshold. The characteristics can be heat—before/after detection differentials of 1 degree C., 0.5 degree C., 0.1 degree C., 0.05 degree C., 0.01 degree C. The characteristics can be can be seismic—before/after detection differentials in ranges such as 1000 HZ, 100 HZ, 10 HZ, 1 HZ, 0.1 HZ, 0.01 HZ, 0.001 HZ. The characteristics can be sound such as—100 dB, 10 dB, 1 dB, 0.1 dB The characteristics can be TDS ranges of 100 F, 10 F, 1 F, 0.1 F, 0.01 F, 0.001 F . . . 0.001 F, 0.0001 F . . . 0.0001 mF . . . 0.0001 uF . . . 0.0001 pF . . . the values we measured in our test were in pico-farads (pF) with a resolution of 0.01 pF. The range in our test data was approximately 10 pF-75 pF. As far as accuracy, that would need to be determined when we develop the sensor algorithm but in general you need an accuracy of half your resolution (i.e. 0.005 pF). As alternatives, the range can be expressed as percents of pre-detection of +/−100%, 90%, 80% . . . 10% . . . 1% . . . 0.1% . . . 0.01% other measurement equivalent (other indirect measures of each)].

In a fourth step 916 the method may include identifying at the one or more underground soil regions a treatment based on the threshold determined in the third step. In a fifth step 918 the method includes executing the treatment needed at regions corresponding to the one or more identified underground soil regions. In a sixth step 920, the soil characteristics may be re-monitored to determine effectiveness of treatment provided in the fifth step 918. The process then ends in step 922 and may be revisited if needed.

Although a few embodiments of the present invention have been shown and described, the present invention is not limited to the described embodiments. It is appreciated by those skilled in the art that changes may be made to the embodiments without departing from the principles and spirit of the invention, the scope of which is defined by the claims and their equivalents. For example, combinations of two or more of the monitoring/sensing techniques may be utilized for higher accuracy in the detection of subterranean termite populations. As another example, an organic termiticide of any suitable type may be used in place of standard termiticide. Yet another example, any suitable pest or insect (e.g. other than termites) may be monitored and treated.

In various embodiments, the insect control system described herein may include various advantages. In one embodiment, the system may be completely automated. The overlapping thermal heat and moisture sensor may minimize or eliminate guess work and labor-intensive, manual checking methods. After detection, a precise amount of insecticide may be dispensed according to the label on the insecticide being used minimizing faulty applications. This will benefit the user, the pest and termite company, and the environment, as unnecessary chemical applications may be minimized. Further, as a termite control device, the system for insect control described herein may assist in placing the termiticide below ground, ensuring minimal losses in an automated, efficient and cost-effective manner. Furthermore, the automated aspect allows for the more frequent use of organic termiticides to achieve the same net effectiveness—further helping the environment by eliminating the use of more harmful petroleum-based chemicals. In one embodiment, the user may use the residence as a vacation home and investment property, and live two states away. The system for insect control described herein may enable the user monitor the lawn visually and parametrically using the computing device including the designated software program. Accordingly, users may be enabled to monitor, determine, identify, and execute the required treatment regimen from a distance using the system for insect control described herein. The system for insect control may also be employed as an irrigation system, and may assist in minimizing water loss by placing the water where it is needed i.e., at the roots to minimize runoff or evaporation.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

FIG. 10 is a block diagram depicting an exemplary client/server system which may be used by an exemplary web-enabled/networked embodiment of the present invention. A communication system 1000 includes a multiplicity of clients with a sampling of clients denoted as a client 1002 and a client 1004, a multiplicity of local networks with a sampling of networks denoted as a local network 1006 and a local network 1008, a global network 1010 and a multiplicity of servers with a sampling of servers denoted as a server 1012 and a server 1014.

Client 1002 may communicate bi-directionally with local network 1006 via a communication channel 1016. Client 1004 may communicate bi-directionally with local network 1008 via a communication channel 1018. Local network 1006 may communicate bi-directionally with global network 1010 via a communication channel 1020. Local network 1008 may communicate bi-directionally with global network 1010 via a communication channel 1022. Global network 1010 may communicate bi-directionally with server 1012 and server 1014 via a communication channel 1024. Server 1012 and server 1014 may communicate bi-directionally with each other via communication channel 1024. Furthermore, clients 1002, 1004, local networks 1006, 1008, global network 1010 and servers 1012, 1014 may each communicate bi-directionally with each other.

In one embodiment, global network 1010 may operate as the Internet. It will be understood by those skilled in the art that communication system 1000 may take many different forms. Non-limiting examples of forms for communication system 1000 include local area networks (LANs), wide area networks (WANs), wired telephone networks, wireless networks, or any other network supporting data communication between respective entities.

Clients 1002 and 1004 may take many different forms. Non-limiting examples of clients 1002 and 1004 include personal computers, personal digital assistants (PDAs), cellular phones and smartphones.

Client 1002 includes a CPU 1026, a pointing device 1028, a keyboard 1030, a microphone 1032, a printer 1034, a memory 1036, a mass memory storage 1038, a GUI 1040, a video camera 1042, an input/output interface 1044, and a network interface 1046.

CPU 1026, pointing device 1028, keyboard 1030, microphone 1032, printer 1034, memory 1036, mass memory storage 1038, GUI 1040, video camera 1042, input/output interface 1044 and network interface 1046 may communicate in a unidirectional manner or a bi-directional manner with each other via a communication channel 1048. Communication channel 1048 may be configured as a single communication channel or a multiplicity of communication channels.

CPU 1026 may be comprised of a single processor or multiple processors. CPU 1026 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1036 is used typically to transfer data and instructions to CPU 1026 in a bi-directional manner. Memory 1036, as discussed previously, may include any suitable computer-readable media, intended for data storage, such as those described above excluding any wired or wireless transmissions unless specifically noted. Mass memory storage 1038 may also be coupled bi-directionally to CPU 1026 and provides additional data storage capacity and may include any of the computer-readable media described above. Mass memory storage 1038 may be used to store programs, data and the like and is typically a secondary storage medium such as a hard disk. It will be appreciated that the information retained within mass memory storage 1038, may, in appropriate cases, be incorporated in standard fashion as part of memory 1036 as virtual memory.

CPU 1026 may be coupled to GUI 1040. GUI 1040 enables a user to view the operation of computer operating system and software. CPU 1026 may be coupled to pointing device 1028. Non-limiting examples of pointing device 1028 include computer mouse, trackball and touchpad. Pointing device 1028 enables a user with the capability to maneuver a computer cursor about the viewing area of GUI 1040 and select areas or features in the viewing area of GUI 1040. CPU 1026 may be coupled to keyboard 1030. Keyboard 1030 enables a user with the capability to input alphanumeric textual information to CPU 1026. CPU 1026 may be coupled to microphone 1032. Microphone 1032 enables audio produced by a user to be recorded, processed and communicated by CPU 1026. CPU 1026 may be connected to printer 1034. Printer 1034 enables a user with the capability to print information to a sheet of paper. CPU 1026 may be connected to video camera 1042. Video camera 1042 enables video produced or captured by user to be recorded, processed and communicated by CPU 1026.

CPU 1026 may also be coupled to input/output interface 1044 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1026 optionally may be coupled to network interface 1046 which enables communication with an external device such as a database or a computer or telecommunications or internet network using an external connection shown generally as communication channel 1016, which may be implemented as a hardwired or wireless communications link using suitable conventional technologies. With such a connection, CPU 1026 might receive information from the network, or might output information to a network in the course of performing the method steps described in the teachings of the present invention. In one embodiment, as a voice communication device any of a computer-type device may be used. For example, such device might have no units 1038, 1040, 1042, 1028, 1030, 1034. In one embodiment, analog voice device which communicates with digital devices via a gateway may also be used.

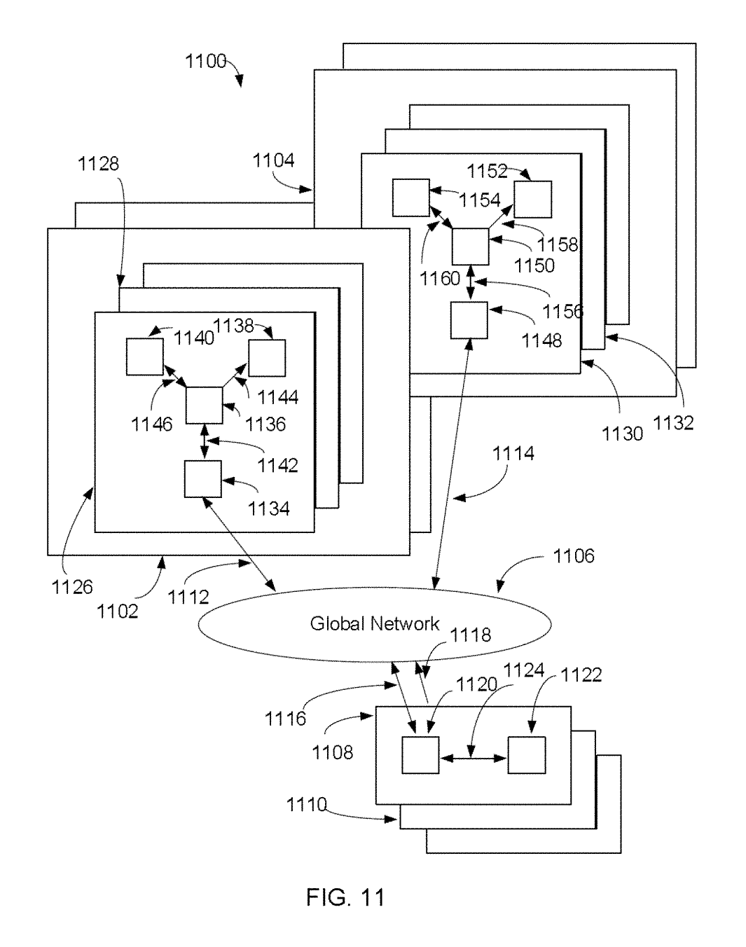

FIG. 11 illustrates a block diagram depicting a conventional client/server communication system. A communication system 1100 includes a multiplicity of networked regions with a sampling of regions denoted as a network region 1102 and a network region 1104, a global network 1106 and a multiplicity of servers with a sampling of servers denoted as a server device 1108 and a server device 1110.

Network region 1102 and network region 1104 may operate to represent a network contained within a geographical area or region. Non-limiting examples of representations for the geographical areas for the networked regions may include postal zip codes, telephone area codes, states, counties, cities and countries. Elements within network region 1102 and 1104 may operate to communicate with external elements within other networked regions or within elements contained within the same network region.

In some implementations, global network 1106 may operate as the Internet. It will be understood by those skilled in the art that communication system 1100 may take many different forms. Non-limiting examples of forms for communication system 1100 include local area networks (LANs), wide area networks (WANs), wired telephone networks, cellular telephone networks or any other network supporting data communication between respective entities via hardwired or wireless communication networks. Global network 1106 may operate to transfer information between the various networked elements.

Server device 1108 and server device 1110 may operate to execute software instructions, store information, support database operations and communicate with other networked elements. Non-limiting examples of software and scripting languages which may be executed on server device 1108 and server device 1110 include C, C++, C# and Java.

Network region 1102 may operate to communicate bi-directionally with global network 1106 via a communication channel 1112. Network region 1104 may operate to communicate bi-directionally with global network 1106 via a communication channel 1114. Server device 1108 may operate to communicate bi-directionally with global network 1106 via a communication channel 1116. Server device 1110 may operate to communicate bi-directionally with global network 1106 via a communication channel 1118. Network region 1102 and 1104, global network 1106 and server devices 1108 and 1110 may operate to communicate with each other and with every other networked device located within communication system 1100.

Server device 1108 includes a networking device 1120 and a server 1122. Networking device 1120 may operate to communicate bi-directionally with global network 1106 via communication channel 1116 and with server 1122 via a communication channel 1124. Server 1122 may operate to execute software instructions and store information.

Network region 1102 includes a multiplicity of clients with a sampling denoted as a client 1126 and a client 1128. Client 1126 includes a networking device 1134, a processor 1136, [a GUI 1138 line interface only and an interface device 1140. Non-limiting examples of devices for GUI 1138 include monitors, televisions, cellular telephones, smartphones and PDAs (Personal Digital Assistants). Non-limiting examples of interface device 1140 include pointing device, mouse, trackball, scanner and printer [interface device may be virtual command line accessed via network (SSH, telnet, etc) or serial port (RS-232, USB, etc)]. Networking device 1134 may communicate bi-directionally with global network 1106 via communication channel 1112 and with processor 1136 via a communication channel 1142. GUI 1138 may receive information from processor 1136 via a communication channel 1144 for presentation to a user for viewing. Interface device 1140 may operate to send control information to processor 1136 and to receive information from processor 1136 via a communication channel 1146. Network region 1104 includes a multiplicity of clients with a sampling denoted as a client 1130 and a client 1132. Client 1130 includes a networking device 1148, a processor 1150, a GUI 1152 and an interface device 1154. Non-limiting examples of devices for GUI 1138 include monitors, televisions, cellular telephones, smartphones and PDAs (Personal Digital Assistants). Non-limiting examples of interface device 1140 include pointing devices, mousse, trackballs, scanners and printers. Networking device 1148 may communicate bi-directionally with global network 1106 via communication channel 1114 and with processor 1150 via a communication channel 1156. GUI 1152 may receive information from processor 1150 via a communication channel 1158 for presentation to a user for viewing. Interface device 1154 may operate to send control information to processor 1150 and to receive information from processor 1150 via a communication channel 1160.

For example, consider the case where a user interfacing with client 1126 may want to execute a networked application. A user may enter the IP (Internet Protocol) address for the networked application using interface device 1140. The IP address information may be communicated to processor 1136 via communication channel 1146. Processor 1136 may then communicate the IP address information to networking device 1134 via communication channel 1142. Networking device 1134 may then communicate the IP address information to global network 1106 via communication channel 1112. Global network 1106 may then communicate the IP address information to networking device 1120 of server device 1108 via communication channel 1116. Networking device 1120 may then communicate the IP address information to server 1122 via communication channel 1124. Server 1122 may receive the IP address information and after processing the IP address information may communicate return information to networking device 1120 via communication channel 1124. Networking device 1120 may communicate the return information to global network 1106 via communication channel 1116. Global network 1106 may communicate the return information to networking device 1134 via communication channel 1112. Networking device 1134 may communicate the return information to processor 1136 via communication channel 1142. Processor 1146 may communicate the return information to GUI 1138 via communication channel 1144. User may then view the return information on GUI 1138.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: databases and application software, operation/support systems, and sensors and sensing networks, and consumables such as pesticide cartridges (solid or liquid), among others.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing the system for insect control according to the present invention will be apparent to those skilled in the art. Various aspects of the invention have been described above by way of illustration, and the specific embodiments disclosed are not intended to limit the invention to the particular forms disclosed. The particular implementation of the system for insect control may vary depending upon the particular context or application. By way of example, and not limitation, the system for insect control described in the foregoing were principally directed to a system for termite control, and the like; however, similar techniques may instead be applied to system for pest control, system for irrigation and the like, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

1. A system comprising:
a first computing device, wherein the first computing device is operably coupled with an insect control device;
the insect control device, wherein the insect control device comprises a second computing device and a sensor, wherein the sensor is enabled to monitor characteristics in a vicinity of the insect control device, wherein the insect control device is partially embedded in soil in the vicinity where the characteristics are monitored, wherein the insect control device transmits the characteristics from the vicinity of the insect control device to the first computing device; and
an insect treatment unit, configured to provide an insect treatment on receiving a communication from the first computing device based on the on the characteristics transmitted by the insect control device.

2. The system of claim 1, wherein the insect treatment unit comprises an insecticide, and wherein the insecticide is stored in an insecticide reservoir, operably coupled with the first computing device, and wherein the first computing device is configured to control release of the insecticide from the insecticide reservoir.

3. The system of claim 1, wherein the insect treatment unit comprises producing a sound or acoustic wave to control a subterranean insect population.

4. The system of claim 1, wherein the insect control device is a termite control device, and wherein the insecticide is a termiticide, an organic composition, an inorganic composition, a petroleum composition, a non-petroleum composition, a plant-based composition.

5. The system of claim 1, wherein the insect control device has a portion above the soil and a portion below the soil, and wherein the insect control devices has sensors in one or both portions.

6. The system of claim 5, wherein the portion below the soil comprises one or more of: TDS sensor, a dielectric mass sensor, a light sensor, a laser sensor, a chemical sensor, a heat sensor; a moisture sensor, a seismic sensor, a vibrational sensor, an acoustic wave sensor, a wind sensor, a humidity sensor, a precipitation sensor, an insulation sensor, a shade sensor, a line of sight sensor.

7. The system of claim 5, wherein the portion above the soil comprises at least one sensor for wind, humidity, precipitation, insulation, shade level, line of sight, or above ground insect activity.

8. The system of claim 1, wherein a plurality of insect control devices is placed in a region in a pattern around a structure, wherein either the region around the structure is to be treated for insect infestation, or wherein the region around the structure is to be protected against insect infestation.

9. The system of claim 1, wherein the plurality of insect control devices is placed such that a range of detection for the sensors in each insect control device may overlap to form a continuous detection ring around the structure

10. The system of claim 1, wherein a dispenser is operably coupled with the insect control device and with the insecticide reservoir, and wherein the dispenser to dispense insecticides comprises a nozzle, a porous reservoir, a tube or array of tubes which are perforated.

11. The system of claim 10, wherein the dispenser is either in the insect control device, in a region close to the insect control device, in network communication with one or more insect control devices, in network communication with one or more reservoirs.

12. A method comprising:
providing a system for insect control, wherein the system comprises a first computing device, and an insect control device, wherein the first computing device is operably coupled with the insect control device;
monitoring characteristics in a plurality of soil regions using the insect control devices, wherein the insect control device comprises a second computing device and a sensor, wherein the sensor is enabled to monitor characteristics in a vicinity of the insect control device, wherein the insect control device is partially embedded in soil in the vicinity where the characteristics are monitored, wherein the insect control device is enabled to transmit the characteristics from the vicinity of the insect control device to the first computing device;
determining whether one or more of the characteristics in one or more of the soil regions are indicative of an insect population exceeding a threshold value, wherein the determining is done by the first computing device using a designated computer program;
identifying a treatment need at the soil regions based on the determining, wherein the identifying is done by the first computing device using a designated computer program; and
executing the treatment need at the soil regions based on the identifying, wherein the executing is done by the first computing device using a designated computer program; and
controlling or eliminating the insect population.

13. The method of claim 12, wherein the characteristics comprise above ground characteristics and below ground characteristics in the vicinity of the insect control device.

14. The method of claim 12, wherein the executing comprises a communication transmitted by the first computing device to an insecticide reservoir to release an insecticide

15. The method of claim 12, wherein the monitoring characteristics comprises monitoring at least one characteristic from above soil level, below soil level, or characteristics from both above soil level and below soil level;
wherein the above soil level characteristics comprises: temperature, humidity, wind speed, insolation, and line of sight; and
wherein the below soil level characteristics comprises: sound or acoustic waves produced by an insect population, propagation characteristics of an electromagnetic wave, dielectric characteristics, Time Domain Reflectometry (TDR) characteristics, thermal characteristics, moisture/humidity characteristics, pH level, a vibration level, an acoustic level, and a mineral level of at least one mineral in the soil.

16. The method of claim 12, wherein the insect control device is enabled to wirelessly transmit the characteristics from the vicinity of the insect control device to the first computing device.

17. The method of claim 12, wherein the determining comprises determining a date, a time, a delayed date and time, for executing the treatment need.

18. The method of claim 12, comprising providing a system for chemi-irrigation control, wherein the system comprises a first computing device, and an insect control device, wherein the first computing device is operably coupled with the insect control device.

19. A method comprising:
placing a body partially embedded in soil, the body having a plurality of perforations below the soil to apply insecticide;
dispensing insecticide through the perforations, through a porous reservoir, or through a gradual leach module; and
minimizing clogging with one or more sieves or screens, wherein the sieve or screen is fitted around or over the body to provide a substantially one-way flow of insecticide outwards therefrom to avoid clogging.

20. A device, comprising:
an insecticide dispenser; and
at least one sensor placed in the portion of the dispenser above or below soil level, wherein the sensor is configured to monitor a below soil level characteristic in the vicinity of the device, wherein the below soil level characteristics comprises: sound or acoustic waves produced by an insect population, propagation characteristics of an electromagnetic wave, dielectric characteristics, Time Domain Reflectometry (TDR) characteristics, thermal characteristics, moisture/humidity characteristics, pH level, a vibration level, an acoustic level, and a mineral level of at least one mineral in the soil; wherein the sensor is configured to monitor a characteristic in the vicinity of the device; and generate an alert or dispense a treatment.
